(19) United States
(12) Patent Application Publication
(10) Pub. No.: US 2026/0254780 A1
(43) Pub. Date: Aug. 27, 2026

(54) SYSTEM

(71) Applicant: SoftBank Group Corp., Tokyo (JP)

(72) Inventor: Manami SEYA, Tokyo (JP)

(73) Assignee: SoftBank Group Corp., Tokyo (JP)

(21) Appl. No.: 19/537,508

(22) Filed: Feb. 12, 2026

(30) Foreign Application Priority Data
Feb. 21, 2025 (JP) 2025-027022

(51) Int. Cl. H04L 51/02; H04L 51/212; H04L 51/216

(52) U.S. Cl. CPC H04L 51/02; H04L 51/212; H04L 51/216

(57) ABSTRACT

The system according to the embodiment comprises a collection unit, an analysis unit, a generation unit, and a provision unit. The collection unit collects message history. The analysis unit analyzes data collected by the collection unit. The generation unit generates a response based on an analysis result obtained by the analysis unit. The provision unit provides the response generated by the generation unit to a user.

### CROSS-REFERENCE TO RELATED APPLICATION

The present application claims priority to and incorporates by reference the entire contents of Japanese Patent Application No. 2025-027022 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, users of messenger applications have faced the problem of being troubled by the effort required to reply and the excessive number of notifications.

### SUMMARY OF THE INVENTION

The system according to the embodiment comprises a collection unit, an analysis unit, a generation unit, and a provision unit. The collection unit collects message history. The analysis unit analyzes data collected by the collection unit. The generation unit generates a response based on an analysis result obtained by the analysis unit. The provision unit provides the response generated by the generation unit to a user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

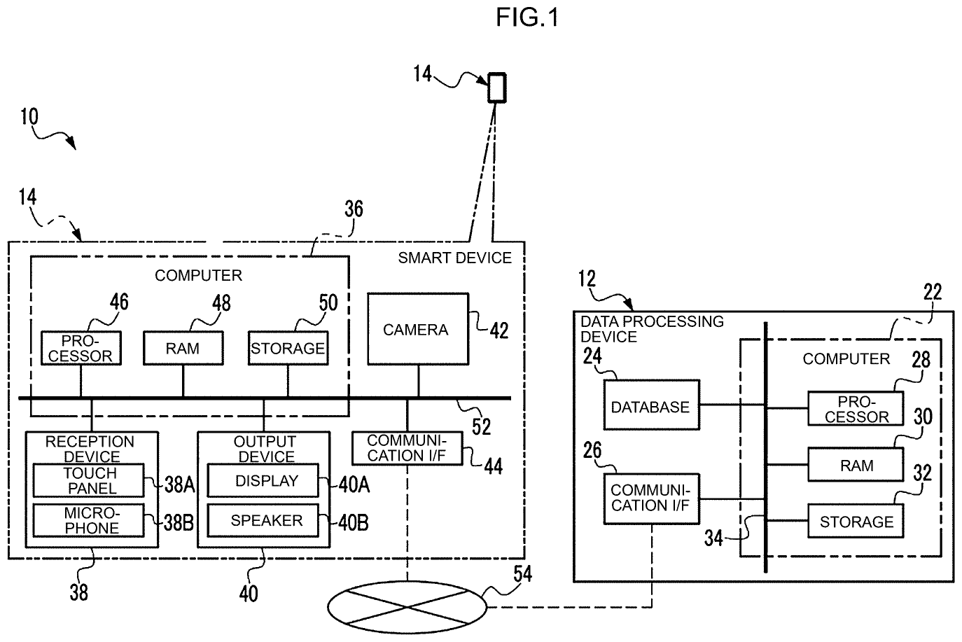

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

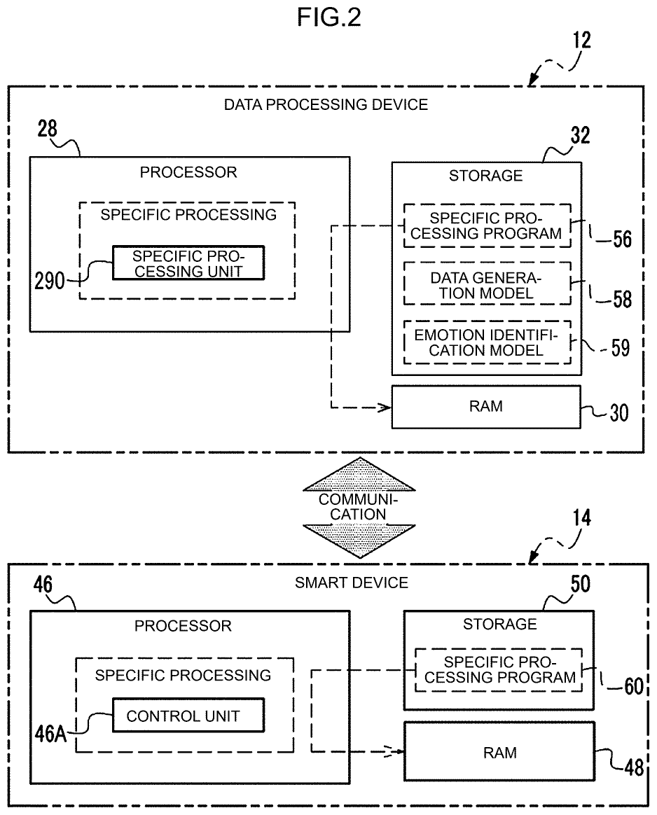

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The automatic response generation system according to the embodiment of the present invention is a system that proposes an automatic response generation bot to solve the problems faced by messenger app users, such as “replying is troublesome” and “notifications tend to accumulate.” This automatic response generation system learns the user's response habits, favorite phrases, and frequency of stamp usage to generate optimal responses. Specifically, the system first collects the user's message history and analyzes it using AI. At this time, data such as what words the user uses and which stamps are frequently used are collected. For example, if the user often uses the word “thank you,” the system learns the frequency and timing of its use. Next, the AI learns the user's response habits and favorite phrases based on the collected data. For example, if the user frequently uses the phrase “got it,” the system learns to use that phrase at appropriate times. The system also learns the frequency of stamp usage and selects appropriate stamps. Furthermore, based on the data learned by the AI, the system generates optimal responses. For example, if a friend asks “What are your plans for today?”, the AI generates a response such as “I don't have any particular plans today” by referring to the user's past responses. It is also possible to select and include appropriate stamps in the reply. With this mechanism, users can automate message replies and prevent notifications from piling up. For example, even in situations where immediate replies are difficult, such as during work or driving, the AI automatically generates replies, allowing users to focus on other tasks with peace of mind. This automatic response generation system analyzes the user's message history and learns response habits, favorite phrases, and stamp usage frequency to generate optimal responses. As a result, users can automate message replies and prevent notification accumulation. Thus, the automatic response generation system enables users to automate message replies and prevent notifications from piling up. Specifically, the automatic response generation system obtains the user's message history data (e.g., text messages as string arrays, voice messages as audio waveform data or spectrograms, image messages as image tensors, etc.) via the collection unit, organizes them in chronological order, and performs preprocessing for natural language processing (e.g., tokenization, stop word removal, morphological analysis) and feature extraction for image and audio data (e.g., image feature extraction using CNN, MFCC conversion of audio spectra, etc.). Next, the analysis unit extracts the user's speech patterns and stamp usage tendencies using, for example, large-scale language models based on Transformer or RNN sequence models, and generates contextual feature vectors for each utterance (e.g., 512-dimensional embedding vectors). Stamp usage frequency is counted by category and quantified using time-series histograms or clustering (e.g., K-means). Examples of AI input include utterance text sequences such as “thank you” and “got it,” time-series arrays of stamp IDs, and feature vectors of image messages. AI outputs include probability distributions of utterance templates for each user (e.g., “thank you” occurrence probability 0.35, “got it” 0.22, etc.), stamp selection probability distributions, and recommended response candidate lists (e.g., text sequences such as “I don't have any particular plans today”). The generation unit uses these outputs to generate natural response texts reflecting the user's habits and favorite phrases using conditional text generation models (e.g., inputting user feature vectors as conditions to a pre-trained large-scale language model). Stamp selection is determined by classification models or reinforcement learning algorithms using past usage frequency and recent conversation context as input. The generated response is either automatically sent via the message app API through the provision unit or presented in a form that allows confirmation and modification on the user interface. As a technical effect, this system not only automates human tasks but also achieves significant improvements in naturalness, diversity, and response accuracy compared to conventional rule-based or simple template responses by extracting patterns in high-dimensional feature spaces for each user and integrating multimodal (text, image, audio) response generation. In addition, parameter optimization of AI models and parallel inference using GPU clusters ensure real-time performance and scalability. Application fields include business chat, customer support, SNS automatic response, voice response for IoT devices, and communication support for people with disabilities. Furthermore, by continuously learning each user's response history, the system can increase the degree of personalization, improve user satisfaction and work efficiency, and reduce stress caused by excessive notifications, resulting in both social and technical benefits.

The automatic response generation system according to the embodiment comprises a collection unit, an analysis unit, a generation unit, and a provision unit. The collection unit collects message history. The message history may include, for example, text messages, voice messages, image messages, and the like, but is not limited to such examples. The collection unit may periodically collect message history from a message app, for example. The collection unit may also collect message history with the user's permission. The analysis unit analyzes data collected by the collection unit. The analysis may use, for example, natural language processing technology or machine learning algorithms. The analysis unit analyzes the user's response habits, favorite phrases, and frequency of stamp usage. For example, if the user frequently uses the word “thank you,” the analysis unit analyzes its frequency and timing. The generation unit generates a response based on the analysis result obtained by the analysis unit. The generation may use, for example, generative AI (such as text generation AI or multimodal generation AI), but is not limited to such examples. The generation unit generates optimal responses by referring to the user's past responses. For example, if a friend asks “What are your plans for today?”, the generation unit generates a response such as “I don't have any particular plans today.” The generation unit may also select appropriate stamps to include in the reply. The provision unit provides the response generated by the generation unit to the user. The provision may include sending the response via a message app, for example. The provision unit may also provide an interface for the user to confirm and modify the response. For example, the provision unit may display the generated response to the user and provide an interface that allows the user to confirm and modify it. Thus, the automatic response generation system according to the embodiment enables users to automate message replies and prevent notifications from piling up. Specifically, the automatic response generation system obtains the user's message history data in various formats (e.g., text messages as string arrays, voice messages as audio waveform data or spectrograms, image messages as image tensors, etc.) via the collection unit and organizes them in chronological order. The collection unit obtains data periodically or by event trigger using the message app API or OS notification mechanism. For privacy protection, the collection unit may perform encryption or anonymization during data acquisition. The analysis unit performs preprocessing for natural language processing (e.g., tokenization, stop word removal, morphological analysis) and feature extraction for image and audio data (e.g., image feature extraction using CNN, MFCC conversion of audio spectra, etc.) on the data received from the collection unit. The analysis unit extracts the user's speech patterns and stamp usage tendencies using, for example, large-scale language models based on Transformer or RNN sequence models, and generates contextual feature vectors for each utterance (e.g., 512-dimensional embedding vectors). Stamp usage frequency is counted by category and quantified using time-series histograms or clustering (e.g., K-means). Examples of AI input include utterance text sequences such as “thank you” and “got it,” time-series arrays of stamp IDs, and feature vectors of image messages. AI outputs include probability distributions of utterance templates for each user (e.g., “thank you” occurrence probability 0.35, “got it” 0.22, etc.), stamp selection probability distributions, and recommended response candidate lists (e.g., text sequences such as “I don't have any particular plans today”). The generation unit uses these outputs to generate natural response texts reflecting the user's habits and favorite phrases using conditional text generation models (e.g., inputting user feature vectors as conditions to a pre-trained large-scale language model). Stamp selection is determined by classification models or reinforcement learning algorithms using past usage frequency and recent conversation context as input. The generated response is either automatically sent via the message app API through the provision unit or presented in a form that allows confirmation and modification on the user interface. As a technical effect, this system not only automates human tasks but also achieves significant improvements in naturalness, diversity, and response accuracy compared to conventional rule-based or simple template responses by extracting patterns in high-dimensional feature spaces for each user and integrating multimodal (text, image, audio) response generation. In addition, parameter optimization of AI models and parallel inference using GPU clusters ensure real-time performance and scalability. Application fields include efficient log collection for business chat, automatic optimization of customer support history, data acquisition for SNS automatic response, communication optimization for IoT devices, and privacy-focused messaging. Furthermore, by continuously learning each user's response history, the system can increase the degree of personalization, improve user satisfaction and work efficiency, and reduce stress caused by excessive notifications, resulting in both social and technical benefits.

Furthermore, the automatic response generation system comprises a local analysis unit for privacy protection. The local analysis unit analyzes data on the user's device. This enables analysis while protecting the user's privacy. For example, the local analysis unit may analyze data in encrypted form. The local analysis unit may also analyze data in anonymized form. Thus, data can be analyzed while protecting the user's privacy. Some or all of the above-described processing in the local analysis unit may be performed using AI or without using AI. For example, the local analysis unit may input data collected on the device to AI and have the AI perform the analysis. Specifically, the local analysis unit directly acquires message history data (e.g., text messages as string arrays, voice messages as PCM waveforms or spectrograms, image messages as RGB image tensors, etc.) within the user's smartphone, tablet, or other terminal, and performs analysis without transmitting the data outside the terminal. The local analysis unit stores data using secure areas or encrypted storage on the terminal, decrypts the data using symmetric encryption methods such as AES during analysis, and promptly re-encrypts or deletes the data after analysis to reduce the risk of information leakage. Furthermore, the local analysis unit hashes and anonymizes user identifiers and utterance content to extract features in a form that cannot identify individuals. When using AI, the local analysis unit may implement lightweight Transformer-based language models or convolutional neural networks (CNN) within the terminal, and input tokenized text message arrays (e.g., up to 128 tokens), MFCC feature vectors of voice messages (e.g., 13 dimensions×100 frames), and 32×32×3 tensors of image messages. The AI model outputs user speech tendency vectors (e.g., 512 dimensions), stamp usage frequency distributions, and image message category labels (e.g., food, landscape, person, etc.) from these inputs. Examples of input include text sequences such as “thank you” and “got it,” time-series arrays of stamp IDs, and image feature vectors. Examples of AI output include “thank you” occurrence probability 0.35, “got it” 0.22, stamp A usage probability 0.18, image category “food” probability 0.41, etc. The local analysis unit stores these outputs in temporary storage within the terminal and, if necessary, transfers them to subsequent generation or provision units, applying encryption or anonymization again during transfer. If AI is not used, rule-based keyword extraction or simple frequency counting algorithms may be executed within the terminal. By introducing the local analysis unit, high-precision feature extraction and analysis can be performed within the terminal without sending personal information to external servers, enabling both privacy protection and AI analysis. As a technical effect, the local analysis unit combines high-dimensional feature extraction and encryption/anonymization processing within the terminal to significantly reduce information leakage risk compared to conventional cloud-dependent analysis, while improving real-time performance and user experience. Furthermore, by applying model compression and quantization techniques (e.g., 8-bit weights, use of distilled models) for on-device AI inference, sufficient analysis accuracy can be ensured even under resource constraints. Application fields include chat response systems in medical, financial, and educational fields requiring high privacy, automatic response in offline environments, and messaging for intranets with a focus on confidentiality.

Furthermore, the automatic response generation system comprises a confirmation unit that allows the user to confirm and modify the generated response. The confirmation unit provides an interface that displays the generated response to the user and allows the user to confirm and modify it. For example, the confirmation unit may display the generated response on the screen and allow the user to manually modify it. The confirmation unit may also allow the user to modify the response using voice input. For example, the user may input modification instructions by voice, and the confirmation unit reflects those instructions. Thus, the user can confirm and modify the automatically generated response. Some or all of the above-described processing in the confirmation unit may be performed using AI or without using AI. For example, the confirmation unit may input the generated response to AI and reflect the user's modification instructions. Specifically, the confirmation unit is designed to display response candidates output from the generation unit (e.g., text sequences, stamp IDs, image messages, etc.) in real time on the user interface, allowing the user to give modification instructions by various means such as touch operation, keyboard input, or speech input via voice recognition. For voice input, the confirmation unit uses an on-device speech recognition engine (e.g., RNN-based acoustic model or Transformer-based end-to-end speech recognition model) to convert audio waveform data (e.g., 16 kHz PCM, about 1-10 seconds) into text sequences, and a natural language understanding module extracts modification intent (e.g., “delete thank you,” “make it more polite,” etc.). When using AI, the confirmation unit inputs the generated response text and user modification instructions (e.g., text sequence “make it shorter,” “add a stamp,” etc.) to a conditional text editing model (e.g., a pre-trained large-scale language model with modification instructions as prompts) to generate modified response candidates. Examples of input include generated response “I don't have any particular plans today,” modification instruction “make it more casual,” voice input “add thank you,” etc. Examples of AI output include modified response “I don't have any particular plans today! Thank you,” modification applied flag (e.g., 1), and modification history data (e.g., difference information indicating which part was changed). As a subsequent process, the confirmation unit may present the modified response to the user again, transfer it to the provision unit after final confirmation, or implement a loop process in which the user can instruct further modifications and input them to the AI editing model again. If AI is not used, simple string replacement or keyword-based modification algorithms may be applied. As a technical effect, the confirmation unit combines AI-based natural language understanding/editing functions and speech recognition/intent extraction functions to provide a faster and more intuitive modification experience than conventional manual editing. Furthermore, by continuously learning modification history and user modification tendencies, the system can realize automatic modification suggestions and improved modification prediction accuracy in the future. Application fields include prevention of erroneous transmission in business chat and customer support, voice modification interfaces for support of people with disabilities, voice response modification for IoT devices, and automatic proofreading of SNS posts. Thus, the confirmation unit brings about substantial improvements in computer technology, such as enhanced user experience, reduced risk of erroneous responses, and advanced AI-based automatic editing technology.

The collection unit is capable of estimating a user's emotion and adjusting the timing of collecting message history based on the estimated emotion of the user. For example, if the user is feeling stressed, the collection unit delays the collection timing to reduce the user's burden. If the user is relaxed, the collection unit may accelerate the collection timing to collect data in near real time. Furthermore, if the user is busy, the collection unit may adjust the collection timing so as not to interfere with the user's work. By adjusting the collection timing according to the user's emotion, the user's burden can be reduced. Emotion estimation is realized by using, for example, an emotion engine or emotion estimation function using generative AI. Generative AI may be text generation AI (e.g., LLM) or multimodal generation AI, but is not limited to such examples. Some or all of the above-described processing in the collection unit may be performed using AI or without using AI. For example, the collection unit may input the user's emotion data to AI and have the AI adjust the collection timing. Specifically, the collection unit collects multidimensional vectors such as message history content (e.g., text sequences, frequency of emoji/stamp usage, prosodic features of voice messages, facial expression analysis results of image messages, etc.) and terminal sensor data (e.g., accelerometer, heart rate, activity log of used apps, etc.) to estimate the user's emotional state. When using AI, the collection unit inputs these data to an emotion estimation model (e.g., BERT-based emotion classification model, multimodal fusion model, etc.) and outputs emotion labels (e.g., stress, relaxation, busy, etc.) and emotion scores (e.g., stress level 0.78, relaxation level 0.12, etc.). Examples of input include the latest 10 text messages (“I can't do it anymore,” “I'm tired,” etc.), time-series arrays of stamp IDs (e.g., consecutive use of angry stamps), MFCC features of voice messages (e.g., 13 dimensions×100 frames), and heart rate time series (e.g., 80, 85, 90 bpm). Examples of AI output include emotion label “stress,” emotion score 0.82, and recommended collection interval (e.g., 30 minutes). Based on these outputs, the collection timing control module dynamically adjusts the data acquisition interval and trigger conditions (e.g., collect only when an event occurs, collect at fixed intervals, etc.). As a subsequent process, the result of collection timing adjustment is notified to the analysis unit and generation unit, contributing to system-wide load balancing and optimization of user experience. If AI is not used, simple rule-based timing control (e.g., reduce collection frequency at night, collect only when specific keywords appear, etc.) may be performed. As a technical effect, the collection unit can estimate the user's emotional state with high accuracy and in real time, and dynamically optimize the collection timing, thereby achieving both significant reduction of user burden and improvement of data quality compared to conventional fixed-interval collection methods. Furthermore, parameter optimization of emotion estimation models and utilization of multimodal input improve stress detection accuracy and flexibility of collection control. Application fields include mental health care support, business efficiency chatbots, student stress monitoring in educational settings, and communication support for people with disabilities. Thus, the collection unit realizes substantial improvements in computer technology by enabling intelligent data collection control according to user state.

The collection unit is capable of analyzing a user's past message history and selecting an appropriate collection method. For example, the collection unit may preferentially collect message history from message apps frequently used by the user. If the user sends many messages during a specific time period, the collection unit may concentrate collection during that time period. Furthermore, if the user frequently interacts with a specific contact, the collection unit may preferentially collect messages exchanged with that contact. By analyzing the user's past message history, the collection unit can select an appropriate collection method. Some or all of the above-described processing in the collection unit may be performed using AI or without using AI. For example, the collection unit may input the user's past message history to AI and have the AI select the optimal collection method. Specifically, the collection unit organizes the user's past message history data (e.g., text messages as string arrays, voice messages as audio waveform data or spectrograms, image messages as image tensors, etc.) in chronological order, and attaches metadata such as sending app ID, recipient ID, sending time, message type (text, voice, image, etc.), and other metadata (e.g., read flag, reply status, etc.) to each message to structure them as high-dimensional feature vectors. The collection unit applies sequence models based on Transformer or time-series clustering algorithms to these history data as input to extract user usage tendencies (e.g., high frequency of sending via a specific app after 6 p.m. on weekdays, more than three exchanges per week with a specific contact, etc.). Examples of AI input include text message arrays for the past 30 days (e.g., 1,000 items), sending app ID arrays for each message (e.g., three types), time stamp arrays for sending times, and time-series arrays of recipient IDs. Examples of AI output include priority scores for each app (e.g., App A: 0.62, App B: 0.28), recommended collection degree for each time period (e.g., 6-9 p.m.: 0.85), and collection priority for each contact (e.g., Contact X: 0.73, Contact Y: 0.15). Based on these outputs, the collection scheduler dynamically optimizes collection frequency and granularity for apps, time periods, and contacts with high priority by controlling API calls and event triggers. As a subsequent process, the collection results are transferred to the analysis unit, which learns the history of collection strategies as feedback and realizes continuous optimization. If AI is not used, simple frequency counting or rule-based collection strategies (e.g., prioritize the app most used in the past week, collect only messages after 8 p.m., etc.) may be used. As a technical effect, the collection unit analyzes user usage tendencies in high-dimensional feature space and dynamically optimizes collection targets, timing, and priority, thereby greatly reducing communication load and storage consumption compared to conventional uniform collection methods, and efficiently acquiring only necessary data. Furthermore, parameter optimization of AI models and parallel inference using GPU clusters ensure real-time performance and scalability. Application fields include efficient log collection for business chat, automatic optimization of customer support history, data acquisition for SNS automatic response, communication optimization for IoT devices, and privacy-focused messaging. Thus, the collection unit realizes substantial improvements in computer technology by enabling intelligent data collection control adapted to user behavior.

The collection unit is capable of performing filtering during collection of message history based on the user's current situation and areas of interest. For example, if the user is at work, the collection unit may preferentially collect work-related messages. If the user frequently sends messages related to hobbies, the collection unit may preferentially collect messages in that field. Furthermore, if the user is traveling, the collection unit may preferentially collect travel-related messages. By performing filtering based on the user's current situation and areas of interest, the collection unit can collect highly relevant data. Some or all of the above-described processing in the collection unit may be performed using AI or without using AI. For example, the collection unit may input data on the user's current situation and areas of interest to AI and have the AI perform filtering. Specifically, the collection unit obtains multidimensional feature vectors such as the user's device state (e.g., calendar schedule, current location, activity log), app usage status (e.g., business app running, frequency of hobby app usage), and recent message content (e.g., text sequences, stamp IDs, image categories, etc.), and uses these as input to estimate the user's current situation (e.g., at work, engaged in hobbies, traveling, etc.) and areas of interest (e.g., sports, music, travel, etc.). When using AI, the collection unit applies multimodal classification models or BERT-based context classification models to output situation labels (e.g., at work, engaged in hobbies, traveling, etc.), areas of interest labels (e.g., sports, music, etc.), and filtering recommendation scores (e.g., work-related 0.92, hobby-related 0.08). Based on these outputs, the collection unit dynamically controls the category and priority of target messages and preferentially collects only highly relevant data. As a subsequent process, the filtering results are transferred to the analysis unit, which uses them to select analysis algorithms and generate responses according to situation and areas of interest. If AI is not used, rule-based filtering based on calendar or app usage history (e.g., collect only work-related messages while business app is running, etc.) may be performed. As a technical effect, the collection unit estimates the user's situation and areas of interest with high accuracy and maximizes the relevance of collected data, thereby reducing noise data and improving storage efficiency compared to conventional indiscriminate collection methods. Furthermore, parameter optimization of AI models and utilization of multimodal input improve responsiveness to situation changes and filtering accuracy. Application fields include business efficiency chatbots, hobby-specific SNS automatic response, travel support apps, and data collection by areas of interest in educational settings. Thus, the collection unit realizes substantial improvements in computer technology by enabling intelligent data collection control adapted to user situation and interests.

The collection unit is capable of estimating a user's emotion and determining a method for deciding the priority of message history to be collected based on the estimated emotion of the user. For example, if the user is feeling stressed, the collection unit postpones collection of messages with low importance. If the user is relaxed, the collection unit may collect all messages equally. Furthermore, if the user is busy, the collection unit may preferentially collect messages with high importance. By determining the priority of message history to be collected according to the user's emotion, the collection unit can preferentially collect important messages. Emotion estimation is realized by using, for example, an emotion engine or emotion estimation function using generative AI. Generative AI may be text generation AI (e.g., LLM) or multimodal generation AI, but is not limited to such examples. Some or all of the above-described processing in the collection unit may be performed using AI or without using AI. For example, the collection unit may input the user's emotion data to AI and have the AI determine the priority of message history to be collected. Specifically, the collection unit collects multidimensional vectors such as recent message content (e.g., text sequences, frequency of emoji/stamp usage, prosodic features of voice messages, facial expression analysis results of image messages, etc.) and terminal sensor data (e.g., heart rate, accelerometer, activity log, etc.) to estimate the user's emotional state, and inputs these to an emotion estimation model (e.g., BERT-based emotion classification model, multimodal fusion model, etc.). Examples of AI input include the latest 10 text messages (“I can't do it anymore,” “I'm tired,” etc.), time-series arrays of stamp IDs (e.g., consecutive use of angry stamps), MFCC features of voice messages (e.g., 13 dimensions×100 frames), and heart rate time series (e.g., 80, 85, 90 bpm). Examples of AI output include emotion label “stress,” emotion score 0.82, and collection priority score list (e.g., high importance 0.91, medium 0.45, low 0.12). Based on these outputs, the collection unit dynamically controls the priority of target messages, preferentially collecting only messages with high importance during stress, collecting all messages equally during relaxation, and prioritizing urgent and important messages when busy. As a subsequent process, the priority assignment result is notified to the analysis unit and generation unit, contributing to system-wide load balancing and optimization of user experience. If AI is not used, rule-based priority determination based on specific keywords or time periods (e.g., collect only important messages at night, etc.) may be performed. As a technical effect, the collection unit can estimate the user's emotional state with high accuracy and in real time, and dynamically optimize collection priority, thereby achieving both significant reduction of user burden and improvement of data quality compared to conventional fixed-priority methods. Furthermore, parameter optimization of emotion estimation models and utilization of multimodal input improve stress detection accuracy and flexibility of collection control. Application fields include mental health care support, business efficiency chatbots, student stress monitoring in educational settings, and communication support for people with disabilities. Thus, the collection unit realizes substantial improvements in computer technology by enabling intelligent data collection control according to user state.

The collection unit is capable of preferentially collecting highly relevant message history based on the user's geographic location information during collection of message history. For example, if the user is at a specific location, the collection unit may preferentially collect messages related to that location. If the user is traveling, the collection unit may preferentially collect messages related to the travel destination. Furthermore, if the user is at home, the collection unit may preferentially collect messages related to home. By considering the user's geographic location information, the collection unit can preferentially collect highly relevant message history. Some or all of the above-described processing in the collection unit may be performed using AI or without using AI. For example, the collection unit may input the user's geographic location information to AI and have the AI collect highly relevant history. Specifically, the collection unit records geographic location data (e.g., latitude/longitude pairs, location category labels such as “home,” “office,” “travel destination,” etc.) obtained from the terminal's GPS, Wi-Fi location information, beacon signals, etc., in chronological order, and manages these in association with message history data (e.g., text sequences, image tensors, recipient IDs, etc.). The collection unit applies geographic context classification models or location-dependent clustering algorithms to these data as input to calculate relevance scores based on current location and movement history. Examples of AI input include time-series location information for the past 24 hours (e.g., 100 locations), arrays of location category labels (e.g., home 5 times, office 3 times, travel destination 2 times), and message content sent at each location (e.g., photo messages sent at travel destinations, etc.). Examples of AI output include collection priority scores for each location (e.g., travel destination 0.88, home 0.12), lists of highly relevant message IDs, and recommended collection categories (e.g., travel-related, home-related, etc.). Based on these outputs, the collection unit dynamically selects target messages according to current location and movement status, and preferentially acquires only highly relevant history. As a subsequent process, the collection results are transferred to the analysis unit, which performs analysis algorithms and response generation according to geographic context. If AI is not used, simple rule-based control using location labels and message categories (e.g., collect only travel-related messages at travel destinations, etc.) may be performed. As a technical effect, the collection unit utilizes the user's geographic location information with high accuracy and maximizes the contextual relevance of collected data, thereby reducing noise data and improving storage efficiency compared to conventional uniform collection methods. Furthermore, parameter optimization of geographic context estimation models and integrated analysis of spatiotemporal data enable flexible collection control during movement and multi-location use. Application fields include travel support apps, location-linked SNS automatic response, on-site information collection for business, and home IoT messaging. Thus, the collection unit realizes substantial improvements in computer technology by enabling intelligent data collection control adapted to geographic context.

The collection unit is capable of analyzing the user's social media activity and collecting related message history during collection of message history. For example, if the user is frequently active on a particular social media platform, the collection unit may preferentially collect messages related to that media. If the user posts frequently about a particular topic, the collection unit may preferentially collect messages related to that topic. Furthermore, if the user belongs to a particular group, the collection unit may preferentially collect messages related to that group. By analyzing the user's social media activity, the collection unit can collect related message history. Some or all of the above-described processing in the collection unit may be performed using AI or without using AI. For example, the collection unit may input the user's social media activity data to AI and have the AI collect related history. Specifically, the collection unit obtains posting history (e.g., text posts, image posts, video posts), activity logs (e.g., likes, comments, shares), group membership information, and topic tags (e.g., #travel, #music, etc.) from multiple social media platforms used by the user via API, organizes them in chronological order, and attaches metadata such as media type, topic category, group ID, etc., to each post/activity to structure them as high-dimensional feature vectors. The collection unit applies topic clustering models or group relevance estimation models to these data as input to calculate relevance scores for the user's topics of interest and activity groups. Examples of AI input include the latest 100 post text sequences, arrays of topic tags (e.g., #travel 20 posts, #music 15 posts), arrays of group IDs (e.g., Group A 10 posts, Group B 5 posts), and activity frequency vectors (e.g., 50 likes, 30 comments, etc.). Examples of AI output include collection priority scores for each media (e.g., SNS A: 0.75, SNS B: 0.25), recommended collection degree for each topic (e.g., travel 0.82, music 0.65), and relevance scores for each group (e.g., Group A: 0.91, Group B: 0.12). Based on these outputs, the collection unit preferentially collects message history linked to highly relevant media, topics, and groups. As a subsequent process, the collection results are transferred to the analysis unit, which performs analysis algorithms and response generation according to social context. If AI is not used, simple rule-based control based on the number of posts or group memberships (e.g., collect only the topic with the most posts, etc.) may be performed. As a technical effect, the collection unit analyzes the user's social media activity in high-dimensional feature space and maximizes the contextual relevance of collected data, thereby reducing noise data and improving storage efficiency compared to conventional uniform collection methods. Furthermore, parameter optimization of topic clustering and group relevance estimation models improves responsiveness to changes in interests and collection accuracy. Application fields include SNS automatic response, topic-specific chatbots, group chat optimization, and marketing analysis support. Thus, the collection unit realizes substantial improvements in computer technology by enabling intelligent data collection control adapted to social context.

The analysis unit is capable of estimating a user's emotion and adjusting the analysis method based on the estimated emotion of the user. For example, if the user is feeling stressed, the analysis unit lowers the level of detail of analysis to simplify it. If the user is relaxed, the analysis unit may increase the level of detail to perform detailed analysis. Furthermore, if the user is busy, the analysis unit may increase the speed of analysis to provide results quickly. By adjusting the analysis method according to the user's emotion, appropriate analysis can be performed. Emotion estimation is realized by using, for example, an emotion engine or emotion estimation function using generative AI. Generative AI may be text generation AI (e.g., LLM) or multimodal generation AI, but is not limited to such examples. Some or all of the above-described processing in the analysis unit may be performed using AI or without using AI. For example, the analysis unit may input the user's emotion data to AI and have the AI adjust the analysis method. Specifically, the analysis unit collects multidimensional vectors such as recent message content (e.g., text sequences, frequency of emoji/stamp usage, prosodic features of voice messages, facial expression analysis results of image messages, etc.) and terminal sensor data (e.g., heart rate, accelerometer, activity log, etc.) to estimate the user's emotional state, and inputs these to an emotion estimation model (e.g., BERT-based emotion classification model, multimodal fusion model, etc.). Examples of AI input include the latest 10 text messages (“I can't do it anymore,” “I'm tired,” etc.), time-series arrays of stamp IDs (e.g., consecutive use of angry stamps), MFCC features of voice messages (e.g., 13 dimensions×100 frames), and heart rate time series (e.g., 80, 85, 90 bpm). Examples of AI output include emotion label “stress,” emotion score 0.82, recommended analysis detail level (e.g., low 0.2, medium 0.5, high 0.9), and recommended analysis speed (e.g., normal 1.0, fast 1.5). Based on these outputs, the analysis unit dynamically controls analysis algorithm parameters (e.g., number of feature extraction dimensions, analysis window width, type of algorithm applied) and processing flow (e.g., presence or absence of detailed analysis path, branching to simplified analysis). For example, when stress level is high, the analysis unit minimizes feature extraction and performs only key keyword extraction and frequency counting; when relaxed, it applies context analysis, time-series clustering, and ensemble analysis with multiple models. If AI is not used, rule-based processing branching according to emotion labels (e.g., simplified analysis during stress, detailed analysis during relaxation, etc.) may be performed. As a technical effect, the analysis unit can estimate the user's emotional state with high accuracy and in real time, and dynamically optimize the analysis method, thereby achieving both efficient use of computational resources and improved user experience, as well as reducing delays and stress caused by unnecessary detailed analysis compared to conventional uniform analysis methods. Furthermore, parameter optimization of emotion estimation models and utilization of multimodal input improve analysis accuracy and flexibility. Application fields include mental health care support chatbots, business efficiency chat systems, student stress monitoring in educational settings, and communication support for people with disabilities. Thus, the analysis unit realizes substantial improvements in computer technology by enabling intelligent analysis control according to user state.

The analysis unit is capable of adjusting the level of detail of analysis based on the importance of the message during analysis. For example, the analysis unit performs detailed analysis for messages with high importance and simplified analysis for messages with low importance. The analysis unit may also prioritize analysis of messages with high importance and postpone analysis of messages with low importance. Furthermore, the analysis unit may apply multiple analysis algorithms to messages with high importance and a single analysis algorithm to messages with low importance. By adjusting the level of detail of analysis based on the importance of the message, efficient analysis can be performed. Some or all of the above-described processing in the analysis unit may be performed using AI or without using AI. For example, the analysis unit may input message importance data to AI and have the AI adjust the level of detail of analysis. Specifically, the analysis unit assigns an importance score (e.g., 0.0-1.0) to each message, and if the importance is high, applies detailed context analysis, emotion analysis, and ensemble inference with multiple models (e.g., BERT-based context understanding+LSTM sequence analysis+rule-based keyword extraction); if the importance is low, performs only simple keyword extraction and frequency counting. Examples of AI input include message text (e.g., “Please respond urgently”), importance score 0.95, recipient ID, and sending time. Examples of AI output include recommended analysis detail level (e.g., high 0.9, low 0.2), list of algorithms to apply (e.g., detailed analysis: BERT+LSTM+rule-based, simplified analysis: rule-based only), and analysis priority (e.g., priority 1, normal 0). Based on these outputs, the analysis unit dynamically optimizes branching control of the analysis pipeline and resource allocation (e.g., GPU allocation, batch size adjustment). For messages with high importance, the analysis unit integrates results from multiple algorithms to maximize analysis accuracy; for messages with low importance, it extracts only the minimum necessary information while reducing computational load. If AI is not used, threshold judgment of importance scores or rule-based switching of analysis detail level may be performed. As a technical effect, the analysis unit optimally allocates analysis resources according to the importance of each message, achieving both computational efficiency and analysis accuracy, improving system scalability, and preventing missed important information. Application fields include priority analysis for business chat, extraction of urgent responses for customer support, detection of important messages for SNS automatic response, and IoT alert analysis. Thus, the analysis unit realizes substantial improvements in computer technology by enabling efficient analysis control adapted to importance.

The analysis unit is capable of applying different analysis algorithms according to the category of the message during analysis. For example, the analysis unit applies business-oriented analysis algorithms to work-related messages. The analysis unit may also apply casual analysis algorithms to private messages. Furthermore, the analysis unit may apply rapid analysis algorithms to urgent messages. By applying different analysis algorithms according to the category of the message, appropriate analysis can be performed. Some or all of the above-described processing in the analysis unit may be performed using AI or without using AI. For example, the analysis unit may input message category data to AI and have the AI apply different analysis algorithms. Specifically, the analysis unit assigns category labels (e.g., business, private, urgent, hobby, etc.) to each message and applies an optimized set of analysis algorithms for each category (e.g., business: BERT-based context understanding+business keyword extraction; private: emotion analysis+casual expression extraction; urgent: fast rule-based+priority judgment). Examples of AI input include message text “Please send the meeting materials urgently,” category label “business,” sending time, and recipient ID. Examples of AI output include list of algorithms to apply (e.g., BERT+business keyword extraction), analysis priority (e.g., high), and analysis detail level (e.g., detailed). Based on these outputs, the analysis unit dynamically optimizes branching control of the analysis pipeline and algorithm selection, realizing optimal information extraction and response generation for each category. If AI is not used, rule-based switching of analysis algorithms according to category labels may be performed. As a technical effect, the analysis unit performs optimized analysis for each message category, greatly improving analysis accuracy, response quality, and processing efficiency compared to conventional uniform analysis methods. Application fields include business efficiency chatbots, private SNS automatic response, urgent report analysis, and hobby-specific messaging. Thus, the analysis unit realizes substantial improvements in computer technology by enabling flexible analysis control adapted to category.

The analysis unit is capable of estimating a user's emotion and determining a method for deciding the priority of analysis based on the estimated emotion of the user. For example, if the user is feeling stressed, the analysis unit postpones analysis of messages with low importance. If the user is relaxed, the analysis unit may analyze all messages equally. Furthermore, if the user is busy, the analysis unit may preferentially analyze messages with high importance. By determining the priority of analysis according to the user's emotion, the analysis unit can preferentially analyze important messages. Emotion estimation is realized by using, for example, an emotion engine or emotion estimation function using generative AI. Generative AI may be text generation AI (e.g., LLM) or multimodal generation AI, but is not limited to such examples. Some or all of the above-described processing in the analysis unit may be performed using AI or without using AI. For example, the analysis unit may input the user's emotion data to AI and have the AI determine the priority of analysis. Specifically, the analysis unit collects multidimensional vectors such as recent message content (e.g., text sequences, frequency of emoji/stamp usage, prosodic features of voice messages, facial expression analysis results of image messages, etc.) and terminal sensor data (e.g., heart rate, accelerometer, activity log, etc.) to estimate the user's emotional state, and inputs these to an emotion estimation model (e.g., BERT-based emotion classification model, multimodal fusion model, etc.). Examples of AI input include the latest 10 text messages (“I can't do it anymore,” “I'm tired,” etc.), time-series arrays of stamp IDs (e.g., consecutive use of angry stamps), MFCC features of voice messages (e.g., 13 dimensions×100 frames), and heart rate time series (e.g., 80, 85, 90 bpm). Examples of AI output include emotion label “stress,” emotion score 0.82, and analysis priority score list (e.g., high importance 0.91, medium 0.45, low 0.12). Based on these outputs, the analysis unit dynamically controls the priority of target messages, preferentially analyzing only messages with high importance during stress, analyzing all messages equally during relaxation, and prioritizing urgent and important messages when busy. As a subsequent process, the priority assignment result is notified to the generation unit and provision unit, contributing to system-wide load balancing and optimization of user experience. If AI is not used, rule-based priority determination based on specific keywords or time periods (e.g., analyze only important messages at night, etc.) may be performed. As a technical effect, the analysis unit can estimate the user's emotional state with high accuracy and in real time, and dynamically optimize analysis priority, thereby achieving both significant reduction of user burden and improvement of data quality compared to conventional fixed-priority methods. Furthermore, parameter optimization of emotion estimation models and utilization of multimodal input improve stress detection accuracy and flexibility of analysis control. Application fields include mental health care support, business efficiency chatbots, student stress monitoring in educational settings, and communication support for people with disabilities. Thus, the analysis unit realizes substantial improvements in computer technology by enabling intelligent analysis control according to user state.

The analysis unit is capable of adjusting the order of analysis based on the sending time of the message during analysis. For example, the analysis unit may preferentially analyze recently sent messages. The analysis unit may also preferentially analyze messages sent before and after important events. Furthermore, the analysis unit may preferentially analyze messages sent by the user during specific time periods. By adjusting the order of analysis based on the sending time of the message, efficient analysis can be performed. Some or all of the above-described processing in the analysis unit may be performed using AI or without using AI. For example, the analysis unit may input message sending time data to AI and have the AI adjust the order of analysis. Specifically, the analysis unit attaches sending time and event labels (e.g., before/after meeting, holiday, late night, etc.) to each message, and applies time-series analysis models (e.g., LSTM sequence models, time-series clustering algorithms, etc.) or event detection algorithms to dynamically determine the order of analysis. Examples of AI input include message text “The meeting is starting,” sending time “2024-06-01 09:00,” event label “before meeting,” and recipient ID. Examples of AI output include analysis priority score (e.g., recent messages 0.95, before/after event 0.88, normal 0.5), and analysis order list (e.g., by message ID). Based on these outputs, the analysis unit rearranges the analysis queue and controls batch processing priority to maximize real-time performance and event responsiveness. If AI is not used, analysis order may be determined by simple rules such as newest sending time or event labels. As a technical effect, the analysis unit controls analysis order according to sending time and event context, improving response speed at important timings and optimizing user experience compared to conventional simple FIFO analysis methods. Application fields include event response in business chat, real-time response in SNS, time-series analysis of IoT alerts, and monitoring of important events in educational settings. Thus, the analysis unit realizes substantial improvements in computer technology by enabling efficient analysis control adapted to time-series and event context.

The analysis unit is capable of improving the accuracy of analysis based on the relevance of the message during analysis. For example, the analysis unit performs detailed analysis for highly relevant messages and simplified analysis for messages with low relevance. The analysis unit may also prioritize analysis of highly relevant messages and postpone analysis of messages with low relevance. Furthermore, the analysis unit may apply multiple analysis algorithms to highly relevant messages and a single analysis algorithm to messages with low relevance. By improving the accuracy of analysis based on the relevance of the message, appropriate analysis can be performed. Some or all of the above-described processing in the analysis unit may be performed using AI or without using AI. For example, the analysis unit may input message relevance data to AI and have the AI improve the accuracy of analysis. Specifically, the analysis unit assigns a relevance score (e.g., 0.0-1.0, similarity to other messages or topic match, etc.) to each message, and if the relevance is high, applies detailed context analysis and ensemble inference with multiple models (e.g., BERT-based context understanding+topic clustering+emotion analysis); if the relevance is low, performs only simple keyword extraction and frequency counting. Examples of AI input include message text “Project progress report,” relevance score 0.92, related topic ID, and recipient ID. Examples of AI output include recommended analysis accuracy (e.g., high 0.9, low 0.2), list of algorithms to apply (e.g., detailed analysis: BERT+clustering+emotion analysis, simplified analysis: rule-based only), and analysis priority (e.g., priority 1, normal 0). Based on these outputs, the analysis unit dynamically optimizes branching control of the analysis pipeline and resource allocation (e.g., GPU allocation, batch size adjustment). For highly relevant messages, the analysis unit integrates results from multiple algorithms to maximize analysis accuracy; for messages with low relevance, it extracts only the minimum necessary information while reducing computational load. If AI is not used, threshold judgment of relevance scores or rule-based switching of analysis accuracy may be performed. As a technical effect, the analysis unit optimally allocates analysis resources according to the relevance of each message, achieving both computational efficiency and analysis accuracy, improving system scalability, and preventing missed important information. Application fields include topic analysis for business chat, extraction of related FAQs for customer support, topic-specific analysis for SNS automatic response, and relevance judgment for IoT alerts. Thus, the analysis unit realizes substantial improvements in computer technology by enabling efficient analysis control adapted to relevance.

The generation unit is capable of estimating a user's emotion and adjusting the expression of the response to be generated based on the estimated emotion of the user. For example, if the user is relaxed, the generation unit uses casual expressions. If the user is feeling stressed, the generation unit may use polite expressions. Furthermore, if the user is excited, the generation unit may use energetic expressions. By adjusting the expression of the response according to the user's emotion, the generation unit can generate appropriate responses. Emotion estimation is realized by using, for example, an emotion engine or emotion estimation function using generative AI. Generative AI may be text generation AI (e.g., LLM) or multimodal generation AI, but is not limited to such examples. Some or all of the above-described processing in the generation unit may be performed using AI or without using AI. For example, the generation unit may input the user's emotion data to AI and have the AI adjust the expression of the response. Specifically, the generation unit collects multidimensional vectors such as recent message content (e.g., text sequences, frequency of emoji/stamp usage, prosodic features of voice messages, facial expression analysis results of image messages, etc.) and terminal sensor data (e.g., heart rate, accelerometer, activity log, etc.) to estimate the user's emotional state, and inputs these to an emotion estimation model (e.g., BERT-based emotion classification model, multimodal fusion model, etc.). Examples of AI input include the latest 10 text messages (“I had fun today,” “I'm tired,” etc.), time-series arrays of stamp IDs (e.g., consecutive use of smiley stamps), MFCC features of voice messages (e.g., 13 dimensions×100 frames), and heart rate time series (e.g., 75, 80, 78 bpm). Examples of AI output include emotion label “relaxation,” emotion score 0.76, and recommended expression type (e.g., casual, polite, energetic, etc.). Based on these outputs, the generation unit uses conditional text generation models (e.g., inputting emotion labels and scores as prompts to a pre-trained large-scale language model) to generate response texts in expression styles according to the user's emotional state (e.g., casual: “I don't have any particular plans today!”, polite: “I do not have any particular plans today,” energetic: “I'm feeling great today!”, etc.). Furthermore, adjustment of expression is realized by controlling various parameters such as sentence endings, tone, frequency of emoji/stamp insertion, writing style (polite/informal), and emphasis (presence of exclamation marks, etc.). If AI is not used, template selection or rule-based sentence ending conversion algorithms according to emotion labels may be applied. The generated response is transferred to the subsequent provision unit and presented or automatically sent to the user. As a technical effect, the generation unit realizes high-precision and real-time expression adjustment reflecting the user's emotional state, greatly improving the naturalness, affinity, and user satisfaction of responses compared to conventional uniform expressions or simple template responses. Furthermore, parameter optimization of emotion estimation models and generation models, and parallel inference using GPU clusters ensure real-time performance and scalability. Application fields include tone adjustment for business chat, situation-adaptive response for customer support, personalized SNS automatic response, communication support for people with disabilities, and emotion-adaptive response for students in educational settings. Thus, the generation unit realizes substantial improvements in computer technology by enabling intelligent expression control adapted to user emotion.

The generation unit is capable of adjusting the level of detail of the response based on the importance of the message during generation. For example, the generation unit generates detailed responses for messages with high importance. The generation unit may also generate concise responses for messages with low importance. Furthermore, the generation unit may generate multiple response options for messages with high importance. By adjusting the level of detail of the response based on the importance of the message, the generation unit can generate appropriate responses. Some or all of the above-described processing in the generation unit may be performed using AI or without using AI. For example, the generation unit may input message importance data to AI and have the AI adjust the level of detail of the response. Specifically, the generation unit assigns an importance score (e.g., 0.0-1.0) to each message, and if the importance is high, applies detailed context analysis and ensemble generation with multiple models (e.g., BERT-based context understanding+LSTM sequence generation+rule-based keyword expansion); if the importance is low, performs only simple template responses or short sentence generation. Examples of AI input include message text “Please respond urgently,” importance score 0.95, recipient ID, and sending time. Examples of AI output include recommended response detail level (e.g., high 0.9, low 0.2), number of response options generated (e.g., three), and list of generation algorithms (e.g., detailed: BERT+LSTM+rule-based, simple: template only). Based on these outputs, the generation unit dynamically optimizes branching control of the generation pipeline and resource allocation (e.g., GPU allocation, batch size adjustment), generating multiple detailed response candidates (e.g., “I will respond immediately,” “I will check right away,” “I am currently responding,” etc.) for messages with high importance, and only concise responses such as “Got it” for messages with low importance. If AI is not used, threshold judgment of importance scores or rule-based switching of response detail level may be performed. The generated multiple responses are transferred to the subsequent confirmation unit or provision unit and presented for user selection or modification. As a technical effect, the generation unit optimally allocates generation resources according to the importance of each message, achieving both computational efficiency and response quality, preventing missed important information, and improving user experience. Application fields include priority response for business chat, urgent response generation for customer support, important message-specific generation for SNS automatic response, and IoT alert response. Thus, the generation unit realizes substantial improvements in computer technology by enabling efficient response generation adapted to importance.

The generation unit is capable of applying different generation algorithms according to the category of the message during generation. For example, the generation unit applies business-oriented generation algorithms to work-related messages. The generation unit may also apply casual generation algorithms to private messages. Furthermore, the generation unit may apply rapid generation algorithms to urgent messages. By applying different generation algorithms according to the category of the message, the generation unit can generate appropriate responses. Some or all of the above-described processing in the generation unit may be performed using AI or without using AI. For example, the generation unit may input message category data to AI and have the AI apply different generation algorithms. Specifically, the generation unit assigns category labels (e.g., business, private, urgent, hobby, etc.) to each message and applies an optimized set of generation algorithms for each category (e.g., business: BERT-based context understanding+business keyword expansion; private: emotion analysis+casual expression generation; urgent: fast rule-based+priority judgment). Examples of AI input include message text “Please send the meeting materials urgently,” category label “business,” sending time, and recipient ID. Examples of AI output include list of generation algorithms to apply (e.g., BERT+business keyword expansion), generation priority (e.g., high), and generation detail level (e.g., detailed). Based on these outputs, the generation unit dynamically optimizes branching control of the generation pipeline and algorithm selection, realizing optimal information extraction and response generation for each category. If AI is not used, rule-based switching of generation algorithms according to category labels may be performed. The generated response is transferred to the subsequent provision unit and presented to the user as a category-adaptive response. As a technical effect, the generation unit performs optimized generation for each message category, greatly improving response quality, generation accuracy, and processing efficiency compared to conventional uniform generation methods. Application fields include business efficiency chatbots, private SNS automatic response, urgent report response, and hobby-specific messaging. Thus, the generation unit realizes substantial improvements in computer technology by enabling flexible response generation adapted to category.

The generation unit can estimate a user's emotion and adjust the length of the response to be generated based on the estimated emotion of the user. For example, the generation unit generates a longer response when the user is relaxed. The generation unit can also generate a shorter response when the user is feeling stressed. Furthermore, the generation unit can generate a concise response when the user is busy. By adjusting the length of the response according to the user's emotion, appropriate responses can be generated. Emotion estimation is realized, for example, by using an emotion estimation function implemented with an emotion engine or a generation AI. The generation AI may be a text generation AI (such as an LLM) or a multimodal generation AI, but is not limited to these examples. Some or all of the above-described processing in the generation unit may be performed using AI or without using AI. For example, the generation unit may input the user's emotion data to AI and have the AI execute the adjustment of response length. Specifically, the generation unit collects recent message content (e.g., text strings, frequency of emoji/stamp usage, prosodic features of voice messages, facial expression analysis results of image messages, etc.) and terminal sensor data (e.g., heart rate, accelerometer, activity log, etc.) as multidimensional vectors to estimate the user's emotional state, and inputs these to an emotion estimation model (e.g., BERT-based emotion classification model, multimodal fusion model, etc.). Examples of AI input include the latest 10 text messages (e.g., “I had fun today”, “I'm tired”), time-series arrays of stamp IDs (e.g., consecutive use of smiley stamps), MFCC features of voice messages (e.g., 13 dimensions×100 frames), and heart rate time series (e.g., 75, 80, 78 bpm). Examples of AI output include emotion label “relaxed”, emotion score 0.76, recommended response length values (e.g., long text 0.85, short text 0.15), etc. Based on these outputs, the generation unit uses a conditional text generation model (e.g., a pre-trained large language model with emotion labels and length constraints as prompts) to generate responses with lengths corresponding to the user's emotional state (e.g., when relaxed: “I don't have any particular plans today. Let me know if anything comes up!”, when stressed: “No particular plans.”, when busy: “OK”, etc.). Furthermore, length adjustment is realized by controlling various parameters such as the number of tokens, number of clauses, amount of information, and presence or absence of supplementary explanations. When not using AI, template selection according to emotion labels or rule-based sentence length control algorithms may be applied. The generated response is transferred to the subsequent provision unit and presented or automatically sent to the user. As a technical effect, the generation unit achieves high-precision and real-time length adjustment reflecting the user's emotional state, greatly improving the naturalness, affinity, and user satisfaction of responses compared to conventional uniform length or simple template responses. In addition, by optimizing parameters of emotion estimation models and generation models and utilizing parallel inference with GPU clusters, real-time performance and scalability can also be ensured. Application fields include tone adjustment in business chat, context-adaptive responses in customer support, personalized automatic responses in SNS, communication support for people with disabilities, and emotion-adaptive responses for students in educational settings. Thus, the generation unit realizes a substantial improvement in computer technology by providing intelligent length control adapted to user emotions.

The generation unit can determine the priority of responses to be generated based on the sending time of messages during generation. For example, the generation unit generates responses preferentially for recently sent messages. The generation unit can also generate responses preferentially for messages sent before or after important events. Furthermore, the generation unit can generate responses preferentially for messages sent by the user during specific time periods. By determining the priority of responses based on the sending time of messages, appropriate responses can be generated at the right timing. Some or all of the above-described processing in the generation unit may be performed using AI or without using AI. For example, the generation unit may input message sending time data to AI and have the AI determine the priority of responses. Specifically, the generation unit assigns sending times and event labels (e.g., before/after meetings, holidays, late night, etc.) to each message, applies time-series analysis models (e.g., LSTM sequence models, time-series clustering algorithms, etc.) and event detection algorithms to dynamically determine the priority of response generation. Examples of AI input include message text “Meeting is starting”, sending time “2024-06-01 09:00”, event label “before meeting”, recipient ID, etc. Examples of AI output include response priority scores (e.g., recent message 0.95, before/after event 0.88, normal 0.5), generation order list (e.g., by message ID), etc. Based on these outputs, the generation unit rearranges the generation queue and controls batch processing priorities to maximize real-time performance and event responsiveness. When not using AI, generation order may be determined by rule-based methods such as newest sending time or event labels. The generated responses are transferred to the subsequent provision unit and presented or automatically sent to the user at appropriate timing. As a technical effect, the generation unit achieves improved response speed at important timings and optimization of user experience compared to conventional simple FIFO generation methods by controlling generation order according to sending time and event context. Application fields include event-responsive business chat, real-time responses in SNS, time-series responses for IoT alerts, and important event monitoring in educational settings. Thus, the generation unit realizes a substantial improvement in computer technology by providing efficient response generation adapted to time-series and event contexts.

The generation unit can adjust the order of responses to be generated based on the relevance of messages during generation. For example, the generation unit generates responses preferentially for highly relevant messages. The generation unit can also generate responses for less relevant messages later. Furthermore, the generation unit can generate multiple response options for highly relevant messages. By adjusting the order of responses based on message relevance, responses can be generated preferentially for highly relevant messages. Some or all of the above-described processing in the generation unit may be performed using AI or without using AI. For example, the generation unit may input message relevance data to AI and have the AI adjust the order of responses. Specifically, the generation unit assigns relevance scores (e.g., 0.0-1.0, similarity to other messages, topic match degree, etc.) to each message, applies detailed context analysis and ensemble generation using multiple models (e.g., BERT-based context understanding+topic clustering+emotion analysis) for highly relevant messages, and applies only simple template responses or short text generation for less relevant messages. Examples of AI input include message text “Project progress report”, relevance score 0.92, related topic ID, recipient ID, etc. Examples of AI output include recommended response generation order values (e.g., high 0.9, low 0.2), number of generation options (e.g., 3), generation algorithm list (e.g., for detailed cases: BERT+clustering+emotion analysis, for simple cases: template only), etc. Based on these outputs, the generation unit dynamically optimizes branching control of the generation pipeline and resource allocation (e.g., GPU allocation, batch size adjustment), generates multiple detailed response candidates for highly relevant messages, and generates only concise responses for less relevant messages. When not using AI, switching of generation order may be performed by threshold judgment of relevance scores or rule-based methods. The generated multiple responses are transferred to the subsequent confirmation unit or provision unit and presented for user selection or modification. As a technical effect, the generation unit optimally allocates generation resources according to the relevance of each message, achieving both computational efficiency and response quality, preventing missing important information, and improving user experience. Application fields include topic responses in business chat, related FAQ generation in customer support, topic-specific automatic responses in SNS, and IoT alert responses. Thus, the generation unit realizes a substantial improvement in computer technology by providing efficient response generation adapted to relevance.

The provision unit can estimate a user's emotion and adjust the display method of the response to be provided based on the estimated emotion of the user. For example, the provision unit provides a casual display method when the user is relaxed. The provision unit can also provide a polite display method when the user is feeling stressed. Furthermore, the provision unit can provide an energetic display method when the user is excited. By adjusting the display method of the response according to the user's emotion, appropriate display methods can be provided. Emotion estimation is realized, for example, by using an emotion estimation function implemented with an emotion engine or a generation AI. The generation AI may be a text generation AI (such as an LLM) or a multimodal generation AI, but is not limited to these examples. Some or all of the above-described processing in the provision unit may be performed using AI or without using AI. For example, the provision unit may input the user's emotion data to AI and have the AI execute the adjustment of the display method. Specifically, the provision unit collects recent message content (e.g., text strings, frequency of emoji/stamp usage, prosodic features of voice messages, facial expression analysis results of image messages, etc.) and terminal sensor data (e.g., heart rate, accelerometer, activity log, etc.) as multidimensional feature vectors to estimate the user's emotional state, and inputs these to an emotion estimation model (e.g., BERT-based emotion classification model, multimodal fusion model, etc.). Examples of AI input include the latest 10 text messages (e.g., “I had fun today”, “I'm tired”), time-series arrays of stamp IDs (e.g., consecutive use of smiley stamps), MFCC features of voice messages (e.g., 13 dimensions×100 frames), and heart rate time series (e.g., 75, 80, 78 bpm). Examples of AI output include emotion label “relaxed”, emotion score 0.76, recommended display type (e.g., casual, polite, energetic), display format parameters (e.g., font size, color, presence of animation), etc. Based on these outputs, the provision unit dynamically switches the display style of the user interface (e.g., pop colors and emphasis on emojis for casual, calm colors and polite expressions for polite, animation and emphasis for energetic). Furthermore, adjustment of the display method is realized by integrally controlling multiple parameters such as font, color scheme, layout, animation effects, notification sound type, and vibration pattern. When not using AI, template selection according to emotion labels or rule-based display switching algorithms may be applied. As a subsequent process, the result of the display method decision is reflected on the user's terminal screen or notification area, contributing to optimization of the user experience. As a technical effect, the provision unit achieves high-precision and real-time display adjustment reflecting the user's emotional state, greatly improving affinity, satisfaction, and stress reduction effects of responses compared to conventional uniform or simple template displays. In addition, by optimizing parameters of emotion estimation models and display control algorithms and utilizing parallel inference with GPU clusters, real-time performance and scalability can also be ensured. Application fields include tone-adaptive display in business chat, context-adaptive UI in customer support, personalized display of automatic responses in SNS, communication support for people with disabilities, and emotion-adaptive display for students in educational settings. Thus, the provision unit realizes a substantial improvement in computer technology by providing intelligent display control adapted to user emotions.

The provision unit can refer to the user's past message history at the time of provision to select the optimal display method. For example, the provision unit preferentially provides display methods that the user has preferred to use in the past. The provision unit can also preferentially provide display methods that the user has used for specific recipients. Furthermore, the provision unit can preferentially provide display methods that the user has used during specific time periods. By referring to the user's past message history, the optimal display method can be selected. Some or all of the above-described processing in the provision unit may be performed using AI or without using AI. For example, the provision unit may input the user's past message history data to AI and have the AI select the optimal display method. Specifically, the provision unit organizes the user's past message history data (e.g., text message string arrays, recipient IDs, sending times, display method IDs, display style parameters, etc.) in chronological order and statistically analyzes the selection tendencies and usage frequencies of display methods for each history. When using AI, the provision unit applies, for example, Transformer-based sequence models or time-series clustering algorithms to these history data as input to extract display method preference patterns for each user (e.g., casual display for specific recipients, dark mode during specific time periods, etc.). Examples of AI input include display method ID arrays for the past 30 days (e.g., casual 10 times, polite 5 times), recipient ID arrays (e.g., recipient A 8 times, recipient B 7 times), timestamp arrays of sending times, display style parameters (e.g., font size, color, etc.), etc. Examples of AI output include priority scores for each display method (e.g., casual 0.62, polite 0.28), recommended display degree for each recipient (e.g., recipient A: casual 0.85), recommended display degree for each time period (e.g., dark mode at night 0.92), etc. Based on these outputs, the provision unit dynamically optimizes the display scheduler for user interface display style, layout, notification method, etc., and automatically selects the display method that best matches the user's past usage tendencies. When not using AI, display strategies may be determined by simple frequency counts or rule-based methods (e.g., prioritize the most frequently used display method in the past week, use dark mode after 8 p.m., etc.). As a subsequent process, the selected display method is reflected on the user's terminal screen or notification area, contributing to optimization of the user experience. As a technical effect, the provision unit analyzes display preferences for each user in a high-dimensional feature space and dynamically optimizes display method, timing, and priority, greatly improving user satisfaction and operational efficiency compared to conventional uniform display methods. In addition, by optimizing AI model parameters and utilizing parallel inference with GPU clusters, real-time performance and scalability can also be ensured. Application fields include personalized UI for business chat, context-adaptive display for customer support, user-specific display for automatic responses in SNS, and user-adaptive notifications for IoT devices. Thus, the provision unit realizes a substantial improvement in computer technology by providing intelligent display control adapted to user behavior.

The provision unit can customize the method of providing responses based on the user's current situation at the time of provision. For example, the provision unit provides a display method related to work when the user is at work. The provision unit can also provide a display method related to the relevant field when the user is sending messages about hobbies. Furthermore, the provision unit can provide a display method related to travel when the user is traveling. By customizing the method of providing responses based on the user's current situation, appropriate provision methods can be provided. Some or all of the above-described processing in the provision unit may be performed using AI or without using AI. For example, the provision unit may input the user's current situation data to AI and have the AI execute customization of the provision method. Specifically, the provision unit acquires the user's terminal state (e.g., calendar schedule, current location, activity log), app usage status (e.g., business app running, frequency of hobby app usage), and recent message content (e.g., text strings, stamp IDs, image categories, etc.) as multidimensional feature vectors, and uses these as input to estimate the user's current situation (e.g., at work, engaged in hobby activities, traveling, etc.) and areas of interest (e.g., sports, music, travel, etc.). When using AI, the provision unit applies, for example, multimodal classification models or BERT-based context classification models to output situation labels (e.g., at work, during hobby, traveling, etc.) and interest area labels (e.g., sports, music, etc.) from the input data. Examples of AI input include calendar schedule “meeting”, current location “office”, recent 10 message contents (e.g., “send materials”, “business trip”, etc.), app usage history (business app launched 5 times/day), etc. Examples of AI output include situation label “at work”, interest area label “business”, display recommendation degree (e.g., work-related 0.92, hobby-related 0.08), etc. Based on these outputs, the provision unit dynamically controls the category and priority of display target messages and preferentially provides only highly relevant display methods. As a subsequent process, the customization result is reflected in the user interface, and the optimal UI or notification method for each situation or area of interest is presented. When not using AI, customization may be performed by rule-based methods based on calendar or app usage history (e.g., only work-related display when business app is running). As a technical effect, the provision unit estimates the user's situation and areas of interest with high accuracy and maximizes the relevance of display data, achieving noise data reduction and improved user experience compared to conventional indiscriminate display methods. In addition, by optimizing AI model parameters and utilizing multimodal input, responsiveness to situation changes and customization accuracy are also improved. Application fields include business efficiency chatbots, hobby-specific SNS automatic responses, travel support apps, and area-of-interest-specific UI display in educational settings. Thus, the provision unit realizes a substantial improvement in computer technology by providing intelligent display control adapted to user situation and interests.

The provision unit can estimate a user's emotion and determine the priority of responses to be provided based on the estimated emotion of the user. For example, the provision unit postpones responses of low importance when the user is feeling stressed. The provision unit can also provide all responses equally when the user is relaxed. Furthermore, the provision unit can provide responses of high importance preferentially when the user is busy. By determining the priority of responses to be provided according to the user's emotion, important responses can be provided preferentially. Emotion estimation is realized, for example, by using an emotion estimation function implemented with an emotion engine or a generation AI. The generation AI may be a text generation AI (such as an LLM) or a multimodal generation AI, but is not limited to these examples. Some or all of the above-described processing in the provision unit may be performed using AI or without using AI. For example, the provision unit may input the user's emotion data to AI and have the AI determine the priority of responses to be provided. Specifically, the provision unit collects recent message content (e.g., text strings, frequency of emoji/stamp usage, prosodic features of voice messages, facial expression analysis results of image messages, etc.) and terminal sensor data (e.g., heart rate, accelerometer, activity log, etc.) as multidimensional feature vectors to estimate the user's emotional state, and inputs these to an emotion estimation model (e.g., BERT-based emotion classification model, multimodal fusion model, etc.). Examples of AI input include the latest 10 text messages (e.g., “I can't take it anymore”, “I'm tired”), time-series arrays of stamp IDs (e.g., consecutive use of angry stamps), MFCC features of voice messages (e.g., 13 dimensions×100 frames), and heart rate time series (e.g., 80, 85, 90 bpm). Examples of AI output include emotion label “stress”, emotion score 0.82, response priority score list (e.g., high importance 0.91, medium 0.45, low 0.12), etc. Based on these outputs, the provision unit dynamically controls the priority of responses to be provided, preferentially providing only highly important responses during stress, providing all responses equally when relaxed, and prioritizing urgent and important responses when busy. As a subsequent process, the result of prioritization is reflected in the user interface or notification area, contributing to optimization of the user experience and prevention of missing important information. When not using AI, priority may be determined by rule-based methods based on specific keywords or time periods (e.g., only provide important responses at night). As a technical effect, the provision unit estimates the user's emotional state with high accuracy and in real time, dynamically optimizing provision priority, achieving both significant reduction of user burden and improvement of information transmission quality compared to conventional fixed priority methods. In addition, by optimizing parameters of emotion estimation models and utilizing multimodal input, stress detection accuracy and flexibility of provision control are also improved. Application fields include mental health care support, business efficiency chatbots, student stress monitoring in educational settings, and communication support for people with disabilities. Thus, the provision unit realizes a substantial improvement in computer technology by providing intelligent information provision control adapted to user state.

The provision unit can select the optimal provision method by considering the user's geographic location information at the time of provision. For example, the provision unit preferentially provides responses related to the location when the user is at a specific place. The provision unit can also preferentially provide responses related to the travel destination when the user is traveling. Furthermore, the provision unit can preferentially provide responses related to the home when the user is at home. By considering the user's geographic location information, the optimal provision method can be selected. Some or all of the above-described processing in the provision unit may be performed using AI or without using AI. For example, the provision unit may input the user's geographic location information to AI and have the AI select the optimal provision method. Specifically, the provision unit records geographic location data (e.g., latitude and longitude pairs, place category labels such as “home”, “office”, “travel destination”, etc.) obtained from the terminal's GPS, Wi-Fi location information, beacon signals, etc., in chronological order, and manages these in association with response candidate data (e.g., text strings, images, stamp IDs, etc.). The provision unit applies geographic context classification models or location-dependent clustering algorithms to these data as input to calculate provision method scores based on current location and movement history. Examples of AI input include time-series location information for the past 24 hours (e.g., 100 locations), place category label arrays (e.g., home 5 times, office 3 times, travel destination 2 times), responses provided at each location (e.g., photo responses at travel destinations), etc. Examples of AI output include provision priority scores for each location (e.g., travel destination 0.88, home 0.12), list of highly relevant response IDs, recommended provision categories (e.g., travel-related, home-related), etc. Based on these outputs, the provision unit dynamically selects responses and display methods according to current location and movement status, and preferentially presents only highly relevant information. As a subsequent process, the provision result is reflected in the user interface or notification area, realizing optimal information transmission according to geographic context. When not using AI, control may be performed by simple location labels and response categories using rule-based methods (e.g., only provide travel-related responses at travel destinations). As a technical effect, the provision unit utilizes the user's geographic location information with high accuracy and maximizes the contextual relevance of provision data, achieving noise data reduction and improved user experience compared to conventional uniform provision methods. In addition, by optimizing parameters of geographic context estimation models and integrating spatiotemporal data analysis, flexible provision control during movement or multi-location use is also possible. Application fields include travel support apps, location-linked SNS automatic responses, on-site information provision in business settings, and home IoT messaging. Thus, the provision unit realizes a substantial improvement in computer technology by providing intelligent information provision control adapted to geographic context.

The provision unit can analyze the user's social media activity at the time of provision to adjust the method of providing responses. For example, the provision unit preferentially provides responses related to a particular media when the user is frequently active on that social media. The provision unit can also preferentially provide responses related to topics on which the user posts frequently. Furthermore, the provision unit can preferentially provide responses related to groups to which the user belongs. By analyzing the user's social media activity, appropriate provision methods can be provided. Some or all of the above-described processing in the provision unit may be performed using AI or without using AI. For example, the provision unit may input the user's social media activity data to AI and have the AI adjust the provision method. Specifically, the provision unit obtains posting history (e.g., text posts, image posts, video posts), activity logs (e.g., likes, comments, shares), group membership information, topic tags (e.g., #travel, #music, etc.) from multiple social media platforms used by the user via API, organizes these in chronological order, and structures them as high-dimensional feature vectors by assigning metadata such as media type, topic category, group ID, etc., to each post and activity. The provision unit applies topic clustering models or group relevance estimation models to these data as input to calculate relevance scores for the user's topics of interest and activity groups. Examples of AI input include the latest 100 post text strings, topic tag arrays (e.g., #travel 20 times, #music 15 times), group ID arrays (e.g., group A 10 times, group B 5 times), activity frequency vectors (e.g., 50 likes, 30 comments), etc. Examples of AI output include provision priority scores for each media (e.g., SNS A: 0.75, SNS B: 0.25), recommended provision degree for each topic (e.g., travel 0.82, music 0.65), relevance scores for each group (e.g., group A: 0.91, group B: 0.12), etc. Based on these outputs, the provision unit preferentially provides responses linked to highly relevant media, topics, and groups. As a subsequent process, the provision result is reflected in the user interface or notification area, realizing optimal information transmission according to social context. When not using AI, control may be performed by rule-based methods based on simple post counts or group memberships (e.g., only provide responses for the most frequently posted topic). As a technical effect, the provision unit analyzes the user's social media activity in a high-dimensional feature space and maximizes the contextual relevance of provision data, achieving noise data reduction and improved user experience compared to conventional uniform provision methods. In addition, by optimizing parameters of topic clustering and group relevance estimation models, responsiveness to changes in interests and provision accuracy are also improved. Application fields include SNS automatic responses, topic-specific chatbots, group chat optimization, and marketing analysis support. Thus, the provision unit realizes a substantial improvement in computer technology by providing intelligent information provision control adapted to social context.

The local analysis unit can estimate a user's emotion and adjust the method of local analysis based on the estimated emotion of the user. For example, the local analysis unit lowers the level of detail and simplifies the analysis when the user is feeling stressed. The local analysis unit can also increase the level of detail and perform detailed analysis when the user is relaxed. Furthermore, the local analysis unit can increase the speed of analysis and provide results quickly when the user is busy. By adjusting the method of local analysis according to the user's emotion, appropriate analysis can be performed. Emotion estimation is realized, for example, by using an emotion estimation function implemented with an emotion engine or a generation AI. The generation AI may be a text generation AI (such as an LLM) or a multimodal generation AI, but is not limited to these examples. Some or all of the above-described processing in the local analysis unit may be performed using AI or without using AI. For example, the local analysis unit may input the user's emotion data to AI and have the AI adjust the method of local analysis. Specifically, the local analysis unit collects recent message content obtained on the user's terminal (e.g., text strings, frequency of emoji/stamp usage, prosodic features of voice messages, facial expression analysis results of image messages, etc.) and terminal sensor data (e.g., heart rate, accelerometer, activity log, etc.) as multidimensional vectors, and inputs these to an emotion estimation model (e.g., BERT-based emotion classification model, multimodal fusion model, etc.). Examples of AI input include the latest 10 text messages (e.g., “I can't take it anymore”, “I'm tired”), time-series arrays of stamp IDs (e.g., consecutive use of angry stamps), MFCC features of voice messages (e.g., 13 dimensions×100 frames), and heart rate time series (e.g., 80, 85, 90 bpm). Examples of AI output include emotion label “stress”, emotion score 0.82, recommended analysis detail level (e.g., low 0.2, medium 0.5, high 0.9), recommended analysis speed (e.g., normal 1.0, fast 1.5), etc. Based on these outputs, the local analysis unit dynamically controls analysis algorithm parameters (e.g., number of feature extraction dimensions, analysis window width, types of algorithms applied) and processing flow (e.g., presence or absence of detailed analysis path, branching to simplified analysis) within the terminal. For example, when stress level is high, only minimal feature extraction and main keyword extraction or frequency counting are performed; when relaxed, context analysis, time-series clustering, and ensemble analysis using multiple models are applied. When not using AI, rule-based processing branching according to emotion labels (e.g., simplified analysis during stress, detailed analysis when relaxed) may be performed. As a subsequent process, the local analysis result is stored in the terminal's cache or temporary storage and transferred to the cloud analysis unit or generation unit as needed. As a technical effect, the local analysis unit estimates the user's emotional state with high accuracy and in real time, dynamically optimizes the analysis method within the terminal, achieving both efficient use of computational resources and improved user experience compared to conventional uniform analysis methods, and reducing delays and stress caused by unnecessary detailed analysis. In addition, by optimizing parameters of emotion estimation models and utilizing multimodal input, analysis accuracy and flexibility are also improved. Application fields include mental health care support chatbots, business efficiency chat systems, student stress monitoring in educational settings, communication support for people with disabilities, and privacy-focused analysis within the terminal. Thus, the local analysis unit realizes a substantial improvement in computer technology by providing intelligent analysis control adapted to user state.

The local analysis unit can adjust the level of detail of analysis based on the importance of messages during local analysis. For example, the local analysis unit performs detailed analysis for highly important messages and simplified analysis for less important messages. The local analysis unit can also prioritize analysis of highly important messages and postpone analysis of less important messages. Furthermore, the local analysis unit can apply multiple analysis algorithms to highly important messages and only a single analysis algorithm to less important messages. By adjusting the level of detail of analysis based on message importance, efficient analysis can be performed. Some or all of the above-described processing in the local analysis unit may be performed using AI or without using AI. For example, the local analysis unit may input message importance data to AI and have the AI adjust the level of detail of analysis. Specifically, the local analysis unit assigns an importance score (e.g., 0.0-1.0) to each message, applies detailed context analysis, emotion analysis, and ensemble inference using multiple models (e.g., BERT-based context understanding+LSTM sequence analysis+rule-based keyword extraction) within the terminal for highly important messages, and performs only simple keyword extraction or frequency counting for less important messages. Examples of AI input include message text (e.g., “Please respond urgently”), importance score 0.95, recipient ID, sending time, etc. Examples of AI output include recommended analysis detail level (e.g., high 0.9, low 0.2), list of algorithms to be applied (e.g., for detailed analysis: BERT+LSTM+rule-based, for simplified analysis: rule-based only), analysis priority (e.g., priority 1, normal 0), etc. Based on these outputs, the local analysis unit dynamically optimizes branching control of the analysis pipeline and resource allocation (e.g., CPU core allocation, batch size adjustment) within the terminal. For highly important messages, results from multiple algorithms are integrated to maximize analysis accuracy, while for less important messages, only the minimum necessary information is extracted to reduce computational load. When not using AI, switching of analysis detail level may be performed by threshold judgment of importance scores or rule-based methods. As a subsequent process, the analysis result is stored in the terminal's cache or temporary storage and transferred to the cloud analysis unit or generation unit as needed. As a technical effect, the local analysis unit optimally allocates analysis resources within the terminal according to the importance of each message, achieving both computational efficiency and analysis accuracy, improving system scalability, and preventing missing important information. Application fields include priority analysis in business chat, urgent response extraction in customer support, important message detection in SNS automatic responses, IoT alert analysis, and privacy-focused analysis within the terminal. Thus, the local analysis unit realizes a substantial improvement in computer technology by providing efficient analysis control adapted to importance.

The local analysis unit can estimate a user's emotion and determine the priority of local analysis based on the estimated emotion of the user. For example, the local analysis unit postpones analysis of less important messages when the user is feeling stressed. The local analysis unit can also analyze all messages equally when the user is relaxed. Furthermore, the local analysis unit can prioritize analysis of highly important messages when the user is busy. By determining the priority of local analysis according to the user's emotion, important messages can be analyzed preferentially. Emotion estimation is realized, for example, by using an emotion estimation function implemented with an emotion engine or a generation AI. The generation AI may be a text generation AI (such as an LLM) or a multimodal generation AI, but is not limited to these examples. Some or all of the above-described processing in the local analysis unit may be performed using AI or without using AI. For example, the local analysis unit may input the user's emotion data to AI and have the AI determine the priority of local analysis. Specifically, the local analysis unit collects recent message content (e.g., text strings, frequency of emoji/stamp usage, prosodic features of voice messages, facial expression analysis results of image messages, etc.) and terminal sensor data (e.g., heart rate, accelerometer, activity log, etc.) as multidimensional vectors to estimate the user's emotional state, and inputs these to an emotion estimation model (e.g., BERT-based emotion classification model, multimodal fusion model, etc.). Examples of AI input include the latest 10 text messages (e.g., “I can't take it anymore”, “I'm tired”), time-series arrays of stamp IDs (e.g., consecutive use of angry stamps), MFCC features of voice messages (e.g., 13 dimensions×100 frames), and heart rate time series (e.g., 80, 85, 90 bpm). Examples of AI output include emotion label “stress”, emotion score 0.82, analysis priority score list (e.g., high importance 0.91, medium 0.45, low 0.12), etc. Based on these outputs, the local analysis unit dynamically controls the priority of messages to be analyzed within the terminal, preferentially analyzing only highly important messages during stress, analyzing all messages equally when relaxed, and prioritizing urgent and important messages when busy. As a subsequent process, the result of prioritization is stored in the terminal's cache or temporary storage and transferred to the cloud analysis unit or generation unit as needed. When not using AI, priority may be determined by rule-based methods based on specific keywords or time periods (e.g., only analyze important messages at night). As a technical effect, the local analysis unit estimates the user's emotional state with high accuracy and in real time, dynamically optimizes analysis priority within the terminal, achieving both significant reduction of user burden and improvement of data quality compared to conventional fixed priority methods. In addition, by optimizing parameters of emotion estimation models and utilizing multimodal input, stress detection accuracy and flexibility of analysis control are also improved. Application fields include mental health care support, business efficiency chatbots, student stress monitoring in educational settings, communication support for people with disabilities, and privacy-focused analysis within the terminal. Thus, the local analysis unit realizes a substantial improvement in computer technology by providing intelligent analysis control adapted to user state.

The local analysis unit can adjust the order of analysis based on the sending time of messages during local analysis. For example, the local analysis unit preferentially analyzes recently sent messages. The local analysis unit can also preferentially analyze messages sent before or after important events. Furthermore, the local analysis unit can preferentially analyze messages sent by the user during specific time periods. By adjusting the order of analysis based on the sending time of messages, efficient analysis can be performed. Some or all of the above-described processing in the local analysis unit may be performed using AI or without using AI. For example, the local analysis unit may input message sending time data to AI and have the AI adjust the order of analysis. Specifically, the local analysis unit assigns sending times and event labels (e.g., before/after meetings, holidays, late night, etc.) to each message, applies time-series analysis models (e.g., LSTM sequence models, time-series clustering algorithms, etc.) and event detection algorithms within the terminal to dynamically determine the order of analysis. Examples of AI input include message text “Meeting is starting”, sending time “2024-06-01 09:00”, event label “before meeting”, recipient ID, etc. Examples of AI output include analysis priority scores (e.g., recent message 0.95, before/after event 0.88, normal 0.5), analysis order list (e.g., by message ID), etc. Based on these outputs, the local analysis unit rearranges the analysis queue and controls batch processing priorities within the terminal to maximize real-time performance and event responsiveness. When not using AI, analysis order may be determined by rule-based methods such as newest sending time or event labels. As a subsequent process, the analysis result is stored in the terminal's cache or temporary storage and transferred to the cloud analysis unit or generation unit as needed. As a technical effect, the local analysis unit achieves improved response speed at important timings and optimization of user experience compared to conventional simple FIFO analysis methods by controlling analysis order according to sending time and event context. Application fields include event-responsive business chat, real-time responses in SNS, time-series analysis for IoT alerts, important event monitoring in educational settings, and privacy-focused analysis within the terminal. Thus, the local analysis unit realizes a substantial improvement in computer technology by providing efficient analysis control adapted to time-series and event contexts.

The confirmation unit can estimate a user's emotion and adjust the method of confirmation based on the estimated emotion of the user. For example, the confirmation unit provides a simplified confirmation method when the user is feeling stressed. The confirmation unit can also provide a detailed confirmation method when the user is relaxed. Furthermore, the confirmation unit can provide a quick confirmation method when the user is busy. By adjusting the method of confirmation according to the user's emotion, appropriate confirmation can be performed. Emotion estimation is realized, for example, by using an emotion estimation function implemented with an emotion engine or a generation AI. The generation AI may be a text generation AI (such as an LLM) or a multimodal generation AI, but is not limited to these examples. Some or all of the above-described processing in the confirmation unit may be performed using AI or without using AI. For example, the confirmation unit may input the user's emotion data to AI and have the AI adjust the method of confirmation. Specifically, the confirmation unit collects recent message content (e.g., text strings, frequency of emoji/stamp usage, prosodic features of voice messages, facial expression analysis results of image messages, etc.) and terminal sensor data (e.g., heart rate, accelerometer, activity log, etc.) as multidimensional feature vectors to estimate the user's emotional state, and inputs these to an emotion estimation model (e.g., BERT-based emotion classification model, multimodal fusion model, etc.). Examples of AI input include the latest 10 text messages (e.g., “I can't take it anymore”, “I'm tired”), time-series arrays of stamp IDs (e.g., consecutive use of angry stamps), MFCC features of voice messages (e.g., 13 dimensions×100 frames), and heart rate time series (e.g., 80, 85, 90 bpm). Examples of AI output include emotion label “stress”, emotion score 0.82, recommended confirmation method values (e.g., simplified 0.9, detailed 0.1, quick 0.8), etc. Based on these outputs, the confirmation unit dynamically controls parameters such as the number of display items in the confirmation interface, degree of omission in confirmation procedures, level of detail in confirmation dialogs, and timeout duration for confirmation responses. For example, when stress level is high, a simple UI such as one-tap confirmation or Yes/No selection is presented; when relaxed, detailed confirmation content (e.g., supplementary explanations for choices, history reference links) is displayed; when busy, the confirmation response timeout is shortened to prompt immediate response. When not using AI, switching of confirmation methods may be performed by rule-based methods according to emotion labels (e.g., simplified confirmation during stress, detailed confirmation when relaxed). As a subsequent process, the confirmation result is transferred to the generation unit or provision unit, contributing to optimization of the user experience and prevention of erroneous operations. As a technical effect, the confirmation unit estimates the user's emotional state with high accuracy and in real time, dynamically optimizes the confirmation method, achieving reduced operational burden, prevention of erroneous confirmation, and improved user satisfaction compared to conventional uniform confirmation methods. In addition, by optimizing parameters of emotion estimation models and confirmation UI control algorithms and utilizing parallel processing with on-device inference or GPU clusters, real-time performance and scalability can also be ensured. Application fields include important operation confirmation in business chat, context-adaptive confirmation in customer support, user state-adaptive confirmation in SNS automatic responses, communication support for people with disabilities, and emotion-adaptive confirmation for students in educational settings. Thus, the confirmation unit realizes a substantial improvement in computer technology by providing intelligent confirmation control adapted to user emotions.

The confirmation unit can refer to the user's past message history at the time of confirmation to select the optimal confirmation method. For example, the confirmation unit preferentially provides confirmation methods that the user has preferred to use in the past. The confirmation unit can also preferentially provide confirmation methods that the user has used for specific recipients. Furthermore, the confirmation unit can preferentially provide confirmation methods that the user has used during specific time periods. By referring to the user's past message history, the optimal confirmation method can be selected. Some or all of the above-described processing in the confirmation unit may be performed using AI or without using AI. For example, the confirmation unit may input the user's past message history data to AI and have the AI select the optimal confirmation method. Specifically, the confirmation unit organizes the user's past message history data (e.g., text message string arrays, recipient IDs, sending times, confirmation method IDs, confirmation style parameters, etc.) in chronological order and statistically analyzes the selection tendencies and usage frequencies of confirmation methods for each history. When using AI, the confirmation unit applies, for example, Transformer-based sequence models or time-series clustering algorithms to these history data as input to extract confirmation method preference patterns for each user (e.g., simplified confirmation for specific recipients, detailed confirmation during specific time periods, etc.). Examples of AI input include confirmation method ID arrays for the past 30 days (e.g., simplified 10 times, detailed 5 times), recipient ID arrays (e.g., recipient A 8 times, recipient B 7 times), timestamp arrays of sending times, confirmation style parameters (e.g., length of confirmation dialog, presence of supplementary explanation), etc. Examples of AI output include priority scores for each confirmation method (e.g., simplified 0.62, detailed 0.28), recommended confirmation degree for each recipient (e.g., recipient A: simplified 0.85), recommended confirmation degree for each time period (e.g., simplified confirmation at night 0.92), etc. Based on these outputs, the confirmation unit dynamically optimizes the confirmation scheduler for user interface confirmation style, layout, notification method, etc., and automatically selects the confirmation method that best matches the user's past usage tendencies. When not using AI, confirmation strategies may be determined by simple frequency counts or rule-based methods (e.g., prioritize the most frequently used confirmation method in the past week, use simplified confirmation after 8 p.m., etc.). As a subsequent process, the selected confirmation method is reflected on the user's terminal screen or notification area, contributing to optimization of the user experience and prevention of erroneous operations. As a technical effect, the confirmation unit analyzes confirmation preferences for each user in a high-dimensional feature space and dynamically optimizes confirmation method, timing, and priority, greatly improving user satisfaction and operational efficiency compared to conventional uniform confirmation methods. In addition, by optimizing AI model parameters and utilizing parallel inference with GPU clusters, real-time performance and scalability can also be ensured. Application fields include personalized confirmation UI for business chat, context-adaptive confirmation for customer support, user-specific confirmation for automatic responses in SNS, and user-adaptive confirmation for IoT devices. Thus, the confirmation unit realizes a substantial improvement in computer technology by providing intelligent confirmation control adapted to user behavior.

The confirmation unit can estimate a user's emotion and determine the priority of confirmation based on the estimated emotion of the user. For example, the confirmation unit postpones confirmation of items of low importance when the user is feeling stressed. The confirmation unit can also perform all confirmations equally when the user is relaxed. Furthermore, the confirmation unit can prioritize confirmation of items of high importance when the user is busy. By determining the priority of confirmation according to the user's emotion, important confirmations can be performed preferentially. Emotion estimation is realized, for example, by using an emotion estimation function implemented with an emotion engine or a generation AI. The generation AI may be a text generation AI (such as an LLM) or a multimodal generation AI, but is not limited to these examples. Some or all of the above-described processing in the confirmation unit may be performed using AI or without using AI. For example, the confirmation unit may input the user's emotion data to AI and have the AI determine the priority of confirmation. Specifically, the confirmation unit collects recent message content (e.g., text strings, frequency of emoji/stamp usage, prosodic features of voice messages, facial expression analysis results of image messages, etc.) and terminal sensor data (e.g., heart rate, accelerometer, activity log, etc.) as multidimensional vectors to estimate the user's emotional state, and inputs these to an emotion estimation model (e.g., BERT-based emotion classification model, multimodal fusion model, etc.). Examples of AI input include the latest 10 text messages (e.g., “I can't take it anymore”, “I'm tired”), time-series arrays of stamp IDs (e.g., consecutive use of angry stamps), MFCC features of voice messages (e.g., 13 dimensions×100 frames), and heart rate time series (e.g., 80, 85, 90 bpm). Examples of AI output include emotion label “stress”, emotion score 0.82, confirmation priority score list (e.g., high importance 0.91, medium 0.45, low 0.12), etc. Based on these outputs, the confirmation unit dynamically controls the priority of confirmation items, preferentially presenting only highly important confirmations during stress, performing all confirmations equally when relaxed, and prioritizing urgent and important confirmations when busy. As a subsequent process, the result of prioritization is transferred to the provision unit or generation unit, contributing to optimization of the user experience and prevention of erroneous confirmation. When not using AI, priority may be determined by rule-based methods based on specific keywords or time periods (e.g., only present important confirmations at night). As a technical effect, the confirmation unit estimates the user's emotional state with high accuracy and in real time, dynamically optimizes confirmation priority, achieving both significant reduction of user burden and improvement of confirmation quality compared to conventional fixed priority methods. In addition, by optimizing parameters of emotion estimation models and utilizing multimodal input, stress detection accuracy and flexibility of confirmation control are also improved. Application fields include mental health care support, business efficiency chatbots, student stress monitoring in educational settings, and communication support for people with disabilities. Thus, the confirmation unit realizes a substantial improvement in computer technology by providing intelligent confirmation control adapted to user state.

The confirmation unit can select the optimal confirmation method by considering the user's geographic location information at the time of confirmation. For example, the confirmation unit provides confirmation methods related to the location when the user is at a specific place. The confirmation unit can also provide confirmation methods related to the travel destination when the user is traveling. Furthermore, the confirmation unit can provide confirmation methods related to the home when the user is at home. By considering the user's geographic location information, the optimal confirmation method can be selected. Some or all of the above-described processing in the confirmation unit may be performed using AI or without using AI. For example, the confirmation unit may input the user's geographic location information to AI and have the AI select the optimal confirmation method. Specifically, the confirmation unit records geographic location data (e.g., latitude and longitude pairs, place category labels such as “home”, “office”, “travel destination”, etc.) obtained from the terminal's GPS, Wi-Fi location information, beacon signals, etc., in chronological order, and manages these in association with confirmation candidate data (e.g., confirmation dialog content, confirmation method ID, etc.). The confirmation unit applies geographic context classification models or location-dependent clustering algorithms to these data as input to calculate confirmation method scores based on current location and movement history. Examples of AI input include time-series location information for the past 24 hours (e.g., 100 locations), place category label arrays (e.g., home 5 times, office 3 times, travel destination 2 times), confirmation method IDs used at each location (e.g., simplified confirmation at travel destination), etc. Examples of AI output include confirmation priority scores for each location (e.g., travel destination 0.88, home 0.12), list of highly relevant confirmation method IDs, recommended confirmation categories (e.g., travel-related, home-related), etc. Based on these outputs, the confirmation unit dynamically selects confirmation items and display methods according to current location and movement status, and preferentially presents only highly relevant confirmation methods. As a subsequent process, the confirmation result is reflected in the user interface or notification area, realizing optimal confirmation experience according to geographic context. When not using AI, control may be performed by simple location labels and confirmation categories using rule-based methods (e.g., only present simplified confirmation at travel destinations). As a technical effect, the confirmation unit utilizes the user's geographic location information with high accuracy and maximizes the contextual relevance of confirmation data, achieving noise data reduction and improved user experience compared to conventional uniform confirmation methods. In addition, by optimizing parameters of geographic context estimation models and integrating spatiotemporal data analysis, flexible confirmation control during movement or multi-location use is also possible. Application fields include travel support apps, location-linked SNS automatic responses, on-site information confirmation in business settings, and home IoT messaging. Thus, the confirmation unit realizes a substantial improvement in computer technology by providing intelligent confirmation control adapted to geographic context.

The system according to the embodiment is not limited to the examples described above and can be variously modified as follows, for example. Specifically, the system can be expanded or modified from various perspectives, such as AI model architecture and learning methods, data flow, input/output specifications, hardware configuration, user interface design, security control, and privacy protection methods. The system can utilize a combination of AI models such as BERT-based natural language understanding models, Transformer sequence models, multimodal fusion models, graph neural networks, self-supervised learning models, and reinforcement learning agents. Regarding data flow, various methods can be adopted, including distributed processing configurations in the cloud, edge, and on-device, stream data analysis, batch processing, real-time inference, and asynchronous event-driven control. As for input/output specifications, the system can flexibly handle various data types, dimensions, and structures, such as text, audio, images, video, sensor data, location information, app usage history, and IoT device data. In terms of hardware configuration, the system can optimize overall performance, security, and scalability by combining GPU-based parallel computing clusters, FPGA accelerators, low-power devices, distributed storage, and secure enclaves. For user interface design, various methods can be adopted, such as voice dialog UI, AR/VR display, haptic feedback, context-adaptive layouts, and personalized UI. Security control and privacy protection methods can combine data anonymization, differential privacy, local analysis/generation, encrypted communication, and access control lists to ensure both user data safety and legal compliance. Furthermore, the system can realize multi-agent cooperative processing by linking multiple AI models, time-series anomaly detection, long-term tracking of user states, self-evolving parameter optimization, and functional expansion through external API integration. With these various modifications and expansions, the system can be applied as a general-purpose and highly functional AI utilization platform not limited to specific applications, covering a wide range of fields such as business efficiency, healthcare support, education, IoT integration, secure communication, and personalized services. As a technical effect, the system achieves comprehensive improvement in processing speed, accuracy, scalability, safety, and user experience compared to conventional technologies through multi-layered optimization of AI models, data flow, hardware, UI, and security. Thus, the system provides a substantial technical improvement that drives the evolution of AI and computer technology.

The analysis unit can estimate a user's interests and areas of concern based on the content of the user's messages and adjust the method of analysis based on the estimated interests and areas of concern. For example, when the user sends many messages related to sports, the analysis unit performs detailed analysis of sports-related messages. When the user is interested in music, the analysis unit can prioritize analysis of music-related messages. Furthermore, when the user shows interest in a specific event, the analysis unit can prioritize analysis of messages related to that event. By adjusting the method of analysis based on the user's interests and areas of concern, more relevant analysis can be performed. Some or all of the above-described processing in the analysis unit may be performed using AI or without using AI. For example, the analysis unit may input the user's interest and concern data to AI and have the AI adjust the method of analysis.

The generation unit can analyze the user's past message history, learn the user's preferred expression style, and generate responses based on that style. For example, when the user prefers casual expressions, the generation unit generates responses using casual expressions. When the user prefers formal expressions, the generation unit can generate responses using formal expressions. Furthermore, when the user prefers humorous expressions, the generation unit can generate responses using humorous expressions. By generating responses based on the user's preferred expression style, more natural communication becomes possible. Some or all of the above-described processing in the generation unit may be performed using AI or without using AI. For example, the generation unit may input the user's expression style data to AI and have the AI generate the response.

The provision unit can adjust the timing of providing a response based on the frequency at which the user sends messages. For example, if the user frequently sends messages, a response is provided promptly. If the user does not send messages often, the provision of the response can be delayed. Furthermore, if the user sends many messages during a specific time period, the response can be provided in accordance with that time period. By adjusting the timing of providing a response based on the user's message sending frequency, it is possible to provide a response at a more appropriate timing. Some or all of the above-described processing in the provision unit may be performed using AI, or may be performed without using AI. For example, the provision unit can input the user's message sending frequency data into AI and have the AI execute the adjustment of the response provision timing.

The collection unit can determine the priority of messages to be collected based on the content of the user's messages. For example, if the user sends a message regarding an important meeting, that message is collected with priority. If the user sends an urgent communication, that message can also be collected with priority. Furthermore, if the user sends messages related to a specific project, messages related to that project can be collected with priority. By determining the priority of messages to be collected based on the content of the user's messages, important messages can be collected preferentially. Some or all of the above-described processing in the collection unit may be performed using AI, or may be performed without using AI. For example, the collection unit can input the user's message content data into AI and have the AI execute the determination of the priority of messages to be collected.

The analysis unit can adjust the analysis method based on the recipient of the user's messages. For example, if the user sends a message to a business partner, business-oriented analysis is performed. If the user sends a message to family or friends, casual analysis can be performed. Furthermore, if the user sends a message to a specific group, analysis related to that group can be performed. By adjusting the analysis method based on the recipient of the user's messages, more appropriate analysis can be performed. Some or all of the above-described processing in the analysis unit may be performed using AI, or may be performed without using AI. For example, the analysis unit can input the user's recipient data into AI and have the AI execute the adjustment of the analysis method.

The generation unit can estimate the user's emotion and adjust the tone of the response to be generated based on the estimated emotion of the user. For example, if the user is sad, a gentle-toned response is generated. If the user is happy, a bright-toned response can be generated. Furthermore, if the user is angry, a calm-toned response can be generated. By adjusting the tone of the response according to the user's emotion, a more appropriate response can be generated. Emotion estimation is realized, for example, by using an emotion engine or an emotion estimation function using a generation AI. The generation AI may be a text generation AI (e.g., LLM) or a multimodal generation AI, but is not limited to such examples. Some or all of the above-described processing in the generation unit may be performed using AI, or may be performed without using AI. For example, the generation unit can input the user's emotion data into AI and have the AI execute the adjustment of the response tone.

The provision unit can estimate the user's emotion and adjust the format of the response to be provided based on the estimated emotion of the user. For example, if the user is relaxed, the response is provided in a casual format. If the user is feeling stressed, the response can be provided in a simple format. Furthermore, if the user is excited, the response can be provided in a visually attractive format. By adjusting the format of the response to be provided according to the user's emotion, a more appropriate response can be provided. Emotion estimation is realized, for example, by using an emotion engine or an emotion estimation function using a generation AI. The generation AI may be a text generation AI (e.g., LLM) or a multimodal generation AI, but is not limited to such examples. Some or all of the above-described processing in the provision unit may be performed using AI, or may be performed without using AI. For example, the provision unit can input the user's emotion data into AI and have the AI execute the adjustment of the response format.

The collection unit can estimate the user's emotion and determine the type of messages to be collected based on the estimated emotion of the user. For example, if the user is feeling stressed, only messages of high importance are collected. If the user is relaxed, all messages can be collected evenly. Furthermore, if the user is busy, messages of high importance can be collected preferentially. By determining the type of messages to be collected according to the user's emotion, important messages can be collected preferentially. Emotion estimation is realized, for example, by using an emotion engine or an emotion estimation function using a generation AI. The generation AI may be a text generation AI (e.g., LLM) or a multimodal generation AI, but is not limited to such examples. Some or all of the above-described processing in the collection unit may be performed using AI, or may be performed without using AI. For example, the collection unit can input the user's emotion data into AI and have the AI execute the determination of the type of messages to be collected.

The analysis unit can estimate the user's emotion and determine the priority of analysis based on the estimated emotion of the user. For example, if the user is feeling stressed, messages of low importance are postponed. If the user is relaxed, all messages can be analyzed evenly. Furthermore, if the user is busy, messages of high importance can be analyzed preferentially. By determining the priority of analysis according to the user's emotion, important messages can be analyzed preferentially. Emotion estimation is realized, for example, by using an emotion engine or an emotion estimation function using a generation AI. The generation AI may be a text generation AI (e.g., LLM) or a multimodal generation AI, but is not limited to such examples. Some or all of the above-described processing in the analysis unit may be performed using AI, or may be performed without using AI. For example, the analysis unit can input the user's emotion data into AI and have the AI execute the determination of the priority of analysis.

The provision unit can estimate the user's emotion and adjust the display method of the response to be provided based on the estimated emotion of the user. For example, if the user is relaxed, a casual display method is provided. If the user is feeling stressed, a polite display method can be provided. Furthermore, if the user is excited, an energetic display method can be provided. By adjusting the display method of the response to be provided according to the user's emotion, a more appropriate display method can be provided. Emotion estimation is realized, for example, by using an emotion engine or an emotion estimation function using a generation AI. The generation AI may be a text generation AI (e.g., LLM) or a multimodal generation AI, but is not limited to such examples. Some or all of the above-described processing in the provision unit may be performed using AI, or may be performed without using AI. For example, the provision unit can input the user's emotion data into AI and have the AI execute the adjustment of the display method.

The following is a brief description of the processing flow of Example of the Embodiment.

Step 1: The collection unit collects message history. The message history includes text messages, voice messages, image messages, and the like. The collection unit can periodically collect message history from a messaging application and may collect it with the user's permission. Step 2: The analysis unit analyzes the data collected by the collection unit. The analysis may use natural language processing technology or machine learning algorithms. The analysis unit analyzes the user's response habits, favorite phrases, frequency of stamp usage, and, for example, analyzes the frequency and timing of words such as “thank you.” Step 3: The generation unit generates a response based on the analysis result obtained by the analysis unit. The generation may use a generation AI (such as a text generation AI or a multimodal generation AI). The generation unit generates an optimal response with reference to the user's past responses, for example, generating a response such as “I don't have any particular plans today.” The generation unit can also select an appropriate stamp and include it in the reply. Step 4: The provision unit provides the response generated by the generation unit to the user. The provision may be performed by sending the response via a messaging application. The provision unit provides an interface for the user to confirm and modify, displays the generated response to the user, and provides an interface that allows the user to confirm and modify the response.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL:https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described collection unit, analysis unit, generation unit, and provision unit is implemented, for example, by at least one of a smart device 14 and a data processing apparatus 12. For example, the collection unit collects message history by a control unit 46A of the smart device 14. The analysis unit analyzes data collected by a specific processing unit 290 of the data processing apparatus 12. The generation unit generates a response based on the analysis result by the specific processing unit 290 of the data processing apparatus 12. The provision unit provides the response generated by the control unit 46A of the smart device 14 to a user. The correspondence between each unit and the apparatus or control unit is not limited to the above examples and various modifications are possible.

### Second Embodiment

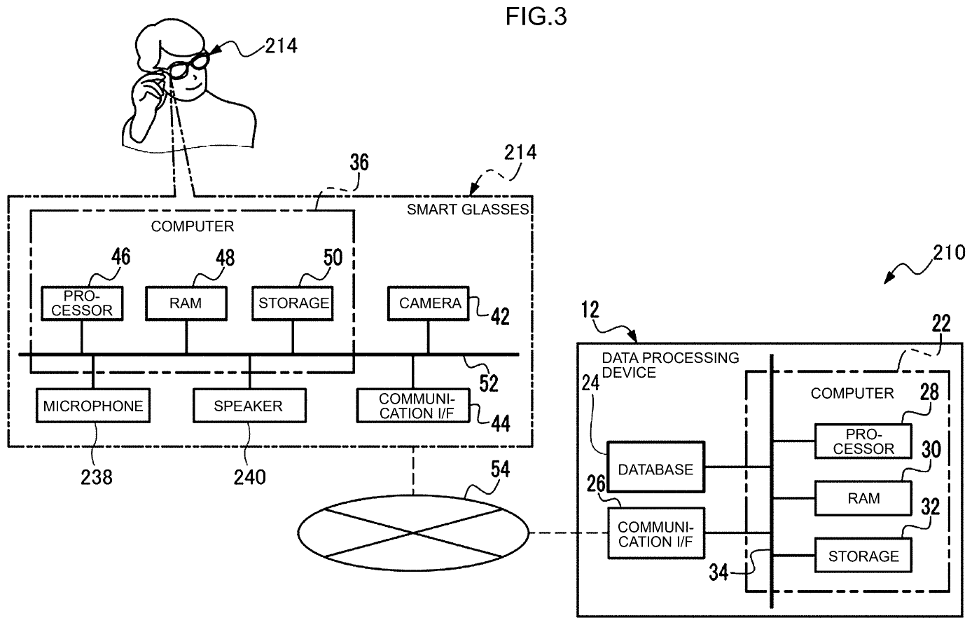

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

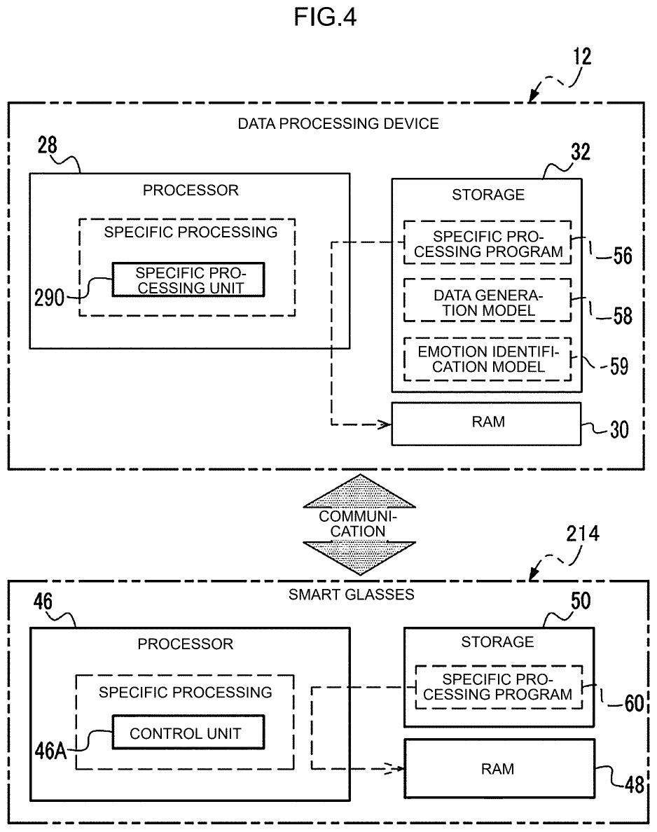

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described collection unit, analysis unit, generation unit, and provision unit is implemented, for example, by at least one of smart glasses 214 and a data processing apparatus 12. For example, the collection unit collects message history by a control unit 46A of the smart glasses 214. The analysis unit analyzes data collected by a specific processing unit 290 of the data processing apparatus 12. The generation unit generates a response based on the analysis result by the specific processing unit 290 of the data processing apparatus 12. The provision unit provides the response generated by the control unit 46A of the smart glasses 214 to a user. The correspondence between each unit and the apparatus or control unit is not limited to the above examples and various modifications are possible. [Third Embodiment]

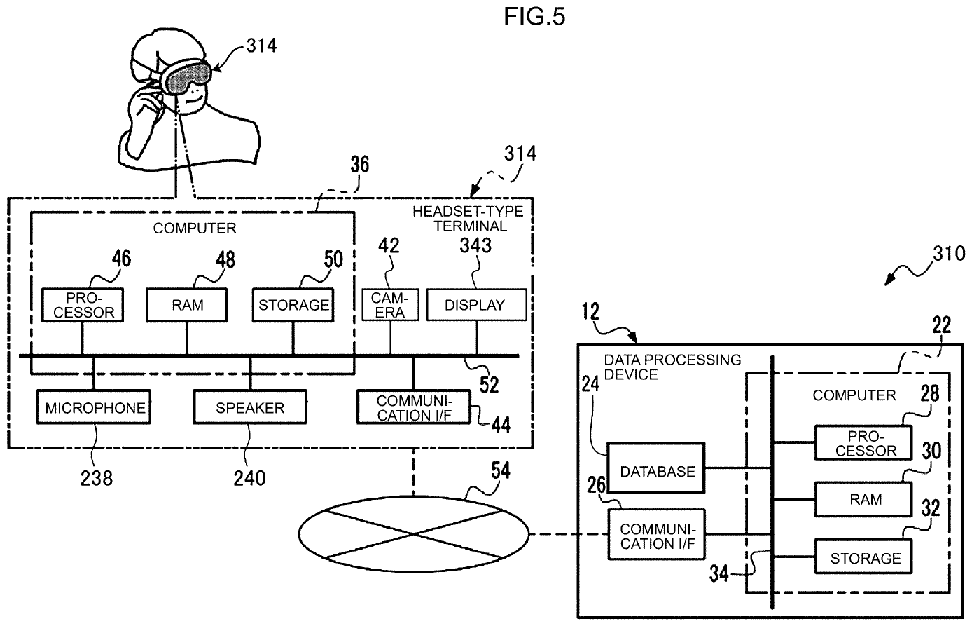

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

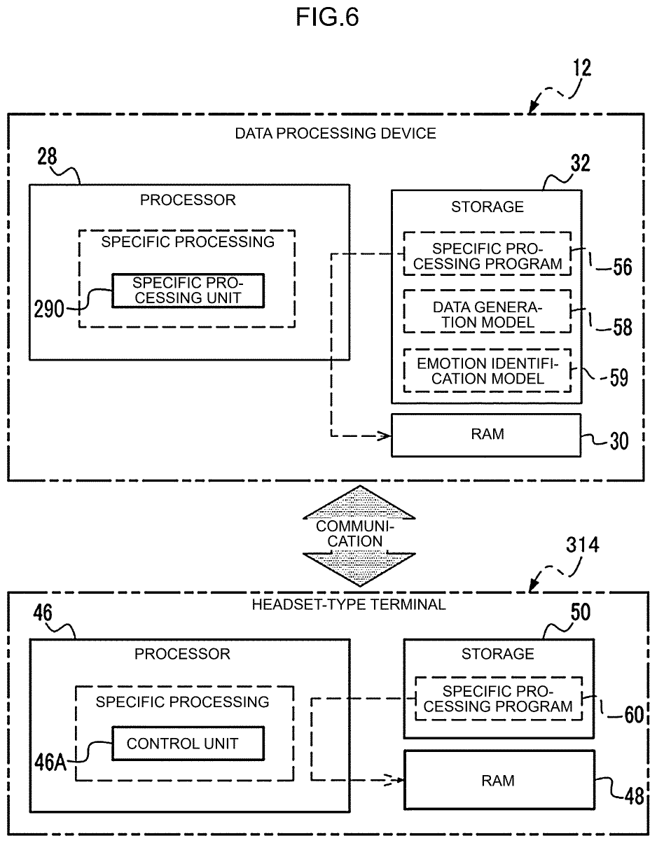

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described collection unit, analysis unit, generation unit, and provision unit is implemented, for example, by at least one of a headset-type terminal 314 and a data processing apparatus 12. For example, the collection unit collects message history by a control unit 46A of the headset-type terminal 314. The analysis unit analyzes data collected by a specific processing unit 290 of the data processing apparatus 12. The generation unit generates a response based on the analysis result by the specific processing unit 290 of the data processing apparatus 12. The provision unit provides the response generated by the control unit 46A of the headset-type terminal 314 to a user. The correspondence between each unit and the apparatus or control unit is not limited to the above examples and various modifications are possible.

### Fourth Embodiment

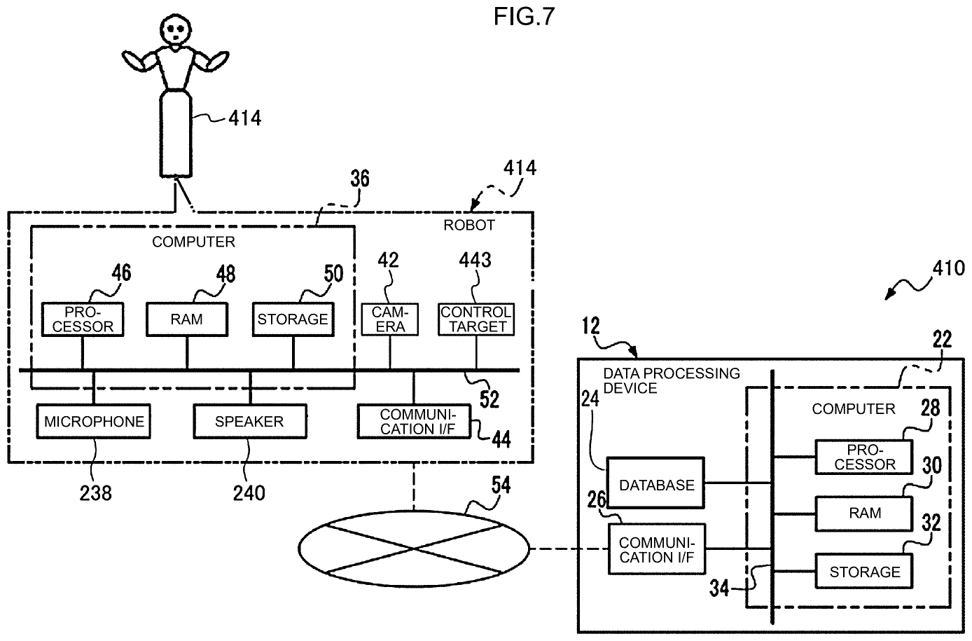

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

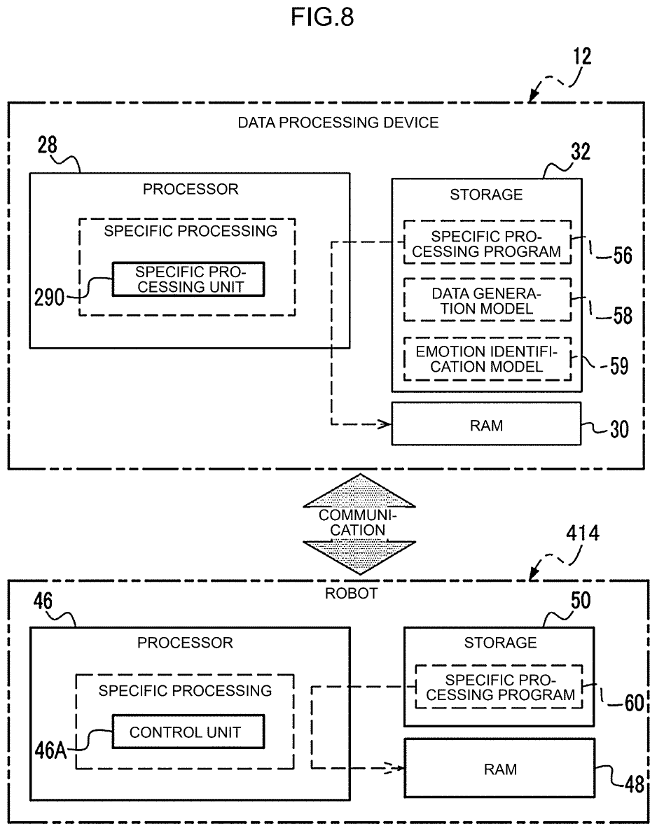

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described collection unit, analysis unit, generation unit, and provision unit is implemented, for example, by at least one of a robot 414 and a data processing apparatus 12. For example, the collection unit collects message history by a control unit 46A of the robot 414. The analysis unit analyzes data collected by a specific processing unit 290 of the data processing apparatus 12. The generation unit generates a response based on the analysis result by the specific processing unit 290 of the data processing apparatus 12. The provision unit provides the response generated by the control unit 46A of the robot 414 to a user. The correspondence between each unit and the apparatus or control unit is not limited to the above examples and various modifications are possible.

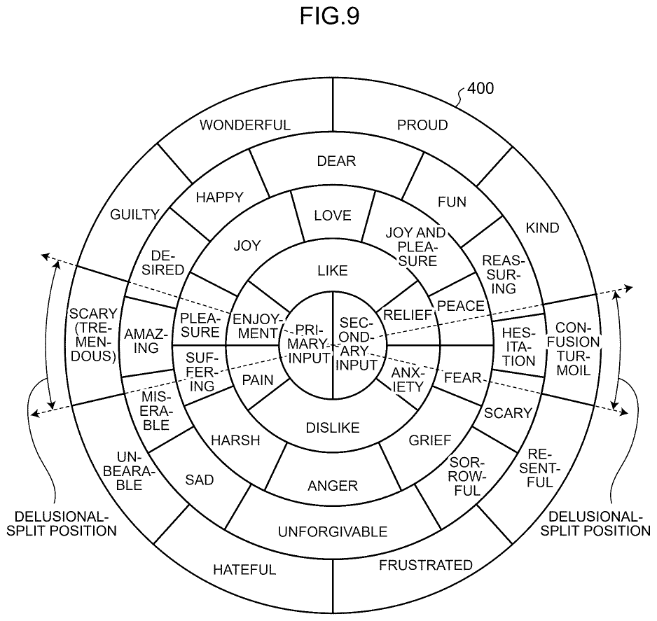

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

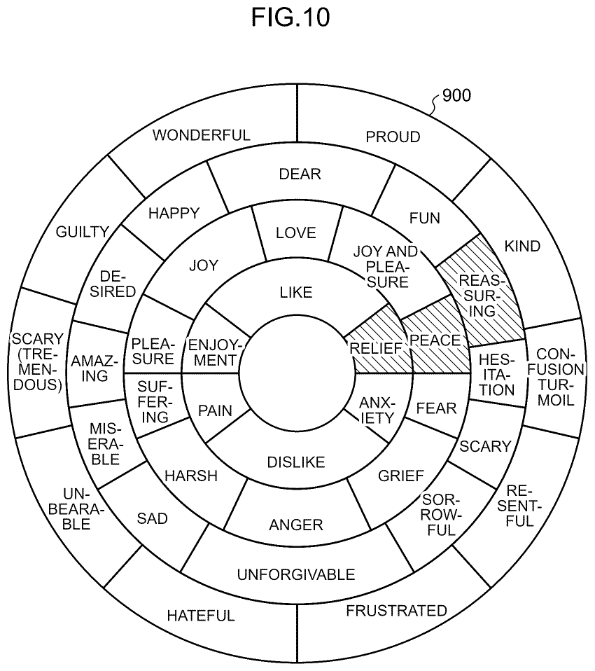

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: a collection unit configured to collect message history; an analysis unit configured to analyze data collected by the collection unit; a generation unit configured to generate a response based on an analysis result obtained by the analysis unit; and a provision unit configured to provide the response generated by the generation unit to a user.
(Supplementary Note 2)The system according to Supplementary Note 1, further comprising a local analysis unit for privacy protection.
(Supplementary Note 3)The system according to Supplementary Note 1, further comprising a confirmation unit configured to allow a user to confirm and modify the generated response.
(Supplementary Note 4)The system according to Supplementary Note 1, wherein the collection unit is configured to estimate a user's emotion and determine a method for adjusting the timing of collecting message history based on the estimated emotion of the user.
(Supplementary Note 5)The system according to Supplementary Note 1, wherein the collection unit is configured to analyze a user's past message history and select an appropriate collection method.
(Supplementary Note 6)The system according to Supplementary Note 1, wherein the collection unit is configured to perform filtering during collection of message history based on the user's current situation and areas of interest.
(Supplementary Note 7)The system according to Supplementary Note 1, wherein the collection unit is configured to estimate a user's emotion and determine a method for deciding the priority of message history to be collected based on the estimated emotion of the user.
(Supplementary Note 8)The system according to Supplementary Note 1, wherein the collection unit is configured to preferentially collect highly relevant message history based on the user's geographic location information during collection of message history.
(Supplementary Note 9)The system according to Supplementary Note 1, wherein the collection unit is configured to analyze the user's social media activity and collect related message history during collection of message history.
(Supplementary Note 10)The system according to Supplementary Note 1, wherein the analysis unit is configured to estimate a user's emotion and determine a method for adjusting the analysis method based on the estimated emotion of the user.
(Supplementary Note 11)The system according to Supplementary Note 1, wherein the analysis unit is configured to adjust the level of detail of analysis based on the importance of the message during analysis.
(Supplementary Note 12)The system according to Supplementary Note 1, wherein the analysis unit is configured to apply different analysis algorithms according to the category of the message during analysis.
(Supplementary Note 13)The system according to Supplementary Note 1, wherein the analysis unit is configured to estimate a user's emotion and determine a method for deciding the priority of analysis based on the estimated emotion of the user.
(Supplementary Note 14)The system according to Supplementary Note 1, wherein the analysis unit is configured to adjust the order of analysis based on the sending time of the message during analysis.
(Supplementary Note 15)The system according to Supplementary Note 1, wherein the analysis unit is configured to improve the accuracy of analysis based on the relevance of the message during analysis.
(Supplementary Note 16)The system according to Supplementary Note 1, wherein the generation unit is configured to estimate a user's emotion and determine a method for adjusting the expression of the response to be generated based on the estimated emotion of the user.
(Supplementary Note 17)The system according to Supplementary Note 1, wherein the generation unit is configured to adjust the level of detail of the response based on the importance of the message during generation.
(Supplementary Note 18)The system according to Supplementary Note 1, wherein the generation unit is configured to apply different generation algorithms according to the category of the message during generation.
(Supplementary Note 19)The system according to Supplementary Note 1, wherein the generation unit is configured to estimate a user's emotion and determine a method for adjusting the length of the response to be generated based on the estimated emotion of the user.
(Supplementary Note 20)The system according to Supplementary Note 1, wherein the generation unit is configured to determine the priority of the response based on the sending time of the message during generation.
(Supplementary Note 21)The system according to Supplementary Note 1, wherein the generation unit is configured to adjust the order of the response based on the relevance of the message during generation.
(Supplementary Note 22)The system according to Supplementary Note 1, wherein the provision unit is configured to estimate a user's emotion and determine a method for adjusting the display method of the response to be provided based on the estimated emotion of the user.
(Supplementary Note 23)The system according to Supplementary Note 1, wherein the provision unit is configured to refer to the user's past message history and select an appropriate display method during provision.
(Supplementary Note 24)The system according to Supplementary Note 1, wherein the provision unit is configured to customize the method of providing the response based on the user's current situation during provision.
(Supplementary Note 25)The system according to Supplementary Note 1, wherein the provision unit is configured to estimate a user's emotion and determine a method for deciding the priority of the response to be provided based on the estimated emotion of the user.
(Supplementary Note 26)The system according to Supplementary Note 1, wherein the provision unit is configured to select an appropriate provision method based on the user's geographic location information during provision.
(Supplementary Note 27)The system according to Supplementary Note 1, wherein the provision unit is configured to analyze the user's social media activity and adjust the method of providing the response during provision.
(Supplementary Note 28)The system according to Supplementary Note 2, wherein the local analysis unit is configured to estimate a user's emotion and determine a method for adjusting the local analysis method based on the estimated emotion of the user.
(Supplementary Note 29)The system according to Supplementary Note 2, wherein the local analysis unit is configured to adjust the level of detail of analysis based on the importance of the message during local analysis.
(Supplementary Note 30)The system according to Supplementary Note 2, wherein the local analysis unit is configured to estimate a user's emotion and determine a method for deciding the priority of local analysis based on the estimated emotion of the user.
(Supplementary Note 31)The system according to Supplementary Note 2, wherein the local analysis unit is configured to adjust the order of analysis based on the sending time of the message during local analysis.
(Supplementary Note 32)The system according to Supplementary Note 3, wherein the confirmation unit is configured to estimate a user's emotion and determine a method for adjusting the confirmation method based on the estimated emotion of the user.
(Supplementary Note 33)The system according to Supplementary Note 3, wherein the confirmation unit is configured to refer to the user's past message history and select an optimal confirmation method during confirmation.
(Supplementary Note 34)The system according to Supplementary Note 3, wherein the confirmation unit is configured to estimate a user's emotion and determine a method for deciding the priority of confirmation based on the estimated emotion of the user.
(Supplementary Note 35)The system according to Supplementary Note 3, wherein the confirmation unit is configured to select an appropriate confirmation method based on the user's geographic location information during confirmation.

What is claimed is:

1. A system comprising:
circuitry configured to:
collect communication data comprising a history of data exchanged between a user and one or more other users via a packet-switched network;
analyze the communication data by extracting, using a trained sequence model, a feature vector representing a behavioral pattern of the user from the communication data;
generate response data by inputting the feature vector into a data generation model to produce a candidate data sequence that reflects the behavioral pattern; and
transmit the response data to a client terminal of the user via the packet-switched network.

2. The system according to claim 1, wherein the communication data comprises at least one of text data, audio waveform data, image data, or stamp identifier data.

3. The system according to claim 1, wherein the circuitry is further configured to perform local analysis of the communication data on the client terminal prior to transmitting the communication data to the circuitry via the packet-switched network, the local analysis comprising at least one of encryption, anonymization, or feature extraction performed within the client terminal.

4. The system according to claim 1, wherein the circuitry is further configured to present the candidate data sequence on the client terminal and receive, from the client terminal, modification instruction data indicating a user modification to the candidate data sequence, and to generate modified response data by inputting the candidate data sequence and the modification instruction data into the data generation model.

5. The system according to claim 1, wherein the circuitry is further configured to estimate an emotion of the user by inputting the communication data into an emotion identification model, the emotion identification model outputting an emotion label and an emotion score, and to adjust a timing of collecting the communication data based on the emotion score.

6. The system according to claim 1, wherein the circuitry is further configured to analyze a past history of the communication data associated with the user and select a collection method for the communication data based on the past history, the collection method comprising at least one of periodic collection or event-triggered collection.

7. The system according to claim 1, wherein the circuitry is further configured to determine a context of the user based on at least one of a calendar schedule, an application usage status, or a geographic location of the client terminal, and to filter the communication data based on the determined context such that data matching the context is preferentially collected.

8. The system according to claim 1, wherein the circuitry is further configured to estimate an emotion of the user by inputting the communication data into an emotion identification model, and to determine a priority of the communication data to be collected based on the estimated emotion, such that when the estimated emotion indicates stress, the circuitry postpones collection of communication data having a low importance attribute.

9. The system according to claim 1, wherein the circuitry is further configured to collect geographic location data from the client terminal and to preferentially collect communication data associated with a current geographic location of the user.

10. The system according to claim 1, wherein the circuitry is further configured to estimate an emotion of the user by inputting the communication data into an emotion identification model, and to adjust a level of detail of analysis of the communication data based on the estimated emotion, such that when the estimated emotion indicates stress, the circuitry reduces the level of detail, and when the estimated emotion indicates relaxation, the circuitry increases the level of detail.

11. The system according to claim 1, wherein the circuitry is further configured to adjust the level of detail of analysis of the communication data based on an importance attribute assigned to each item of the communication data, such that communication data having a high importance attribute is analyzed with greater detail than communication data having a low importance attribute.

12. The system according to claim 1, wherein the circuitry is further configured to assign a category label to each item of the communication data, the category label being one of business, private, or urgent, and to apply a different analysis algorithm to the communication data based on the assigned category label.

13. The system according to claim 1, wherein the circuitry is further configured to estimate an emotion of the user by inputting the communication data into an emotion identification model, and to adjust an expression style of the candidate data sequence based on the estimated emotion, such that when the estimated emotion indicates sadness, the circuitry generates the candidate data sequence having a gentle tone, and when the estimated emotion indicates happiness, the circuitry generates the candidate data sequence having a bright tone.

14. The system according to claim 1, wherein the circuitry is further configured to adjust a level of detail of the candidate data sequence based on an importance attribute of the communication data, such that communication data having a high importance attribute results in a more detailed candidate data sequence.

15. The system according to claim 1, wherein the circuitry is further configured to estimate an emotion of the user by inputting the communication data into an emotion identification model, and to adjust a display method of the response data transmitted to the client terminal based on the estimated emotion, such that when the estimated emotion indicates stress, the response data is transmitted in a simplified format, and when the estimated emotion indicates relaxation, the response data is transmitted in a detailed format.

16. The system according to claim 1, wherein the circuitry is further configured to analyze social media activity data of the user received from the client terminal, and to preferentially collect communication data associated with a topic identified from the social media activity data.

17. The system according to claim 1, wherein the trained sequence model comprises at least one of a Transformer-based language model or a recurrent neural network sequence model, and wherein the feature vector comprises a multidimensional embedding vector representing contextual features of utterances of the user.

18. A system comprising:
a communication interface connected to a packet-switched network;
a processor;
a random-access memory; and
a memory storing a data generation model and an emotion identification model, the processor being configured to read and execute a program stored in the memory on the random-access memory, the processor thereby operating as circuitry configured to:
collect, via the communication interface, communication data comprising a history of text data, audio waveform data, and image data exchanged between a user operating a client terminal and one or more other users via the packet-switched network;
analyze the communication data by extracting, using a trained sequence model comprising at least one of a Transformer-based language model or a recurrent neural network, a multidimensional embedding vector representing a behavioral pattern of the user, the behavioral pattern comprising at least a response habit, a preferred phrase frequency, and a stamp usage frequency;
estimate an emotion of the user by inputting the communication data into the emotion identification model, the emotion identification model outputting an emotion label and an emotion score;
generate response data by inputting the multidimensional embedding vector and the emotion score into the data generation model, the data generation model comprising a conditional text generation model that produces a candidate data sequence reflecting the behavioral pattern and the estimated emotion; and
transmit, via the communication interface, the response data to the client terminal via the packet-switched network.

19. The system according to claim 18, wherein the circuitry is further configured to present the candidate data sequence on the client terminal via the communication interface, receive modification instruction data from the client terminal indicating a user modification, and generate modified response data by inputting the candidate data sequence and the modification instruction data into the data generation model.

20. A method performed by circuitry of a system, the method comprising:
collecting communication data comprising a history of data exchanged between a user and one or more other users via a packet-switched network;
analyzing the communication data by extracting, using a trained sequence model, a feature vector representing a behavioral pattern of the user from the communication data;
generating response data by inputting the feature vector into a data generation model to produce a candidate data sequence that reflects the behavioral pattern; and
transmitting the response data to a client terminal of the user via the packet-switched network.
